(19) United States
(12) Patent Application Publication
(10) Pub. No.: US 2017/0217696 A1
(43) Pub. Date: Aug. 3, 2017

(54) LIFT BEAM SYSTEM

(71) Applicant: Mi-Jack Products, Inc., Hazel Crest, IL (US)

(72) Inventors: John J. Lanigan, Sr., Orland Park, IL (US); Martin C. Conneally, Downers Grove, IL (US); Antonio Carlos Callado Souza, Chicago, IL (US); Jason Schmidt, Flossmoor, IL (US); Kevin Gerald Muszynski, Lockport, IL (US)

(21) Appl. No.: 15/418,306

(22) Filed: Jan. 27, 2017

Related U.S. Application Data
(60) Provisional application No. 62/288,248, filed on Jan. 28, 2016.

(51) Int. Cl. B65G 67/02; B65G 1/02

(52) U.S. Cl. CPC B65G 67/02; B65G 1/026

(57) ABSTRACT

A system for handling shipping containers having first and second lift beams, first and second support beams, and a plurality of vertical beams wherein the plurality of vertical beams are connected by the first and second lift beams and the first and second support beams. The system further includes first and second pluralities of lifting pads disposed respectively on each of the first and second lift beams wherein the lifting pads of the first and second pluralities are arranged to have an initial position recessed within the respective lift beam on which each lifting pad is disposed and the lifting pads of the first and second pluralities are arranged to have a deployed position distal to the respective lift beam on which each lifting pad is disposed. Further still, the system has first and second pluralities of swivel feet disposed respectively on each of the first and second support beams and a lift beam driving mechanism that raises and lowers the first and second lift beams.

### CROSS REFERENCE TO RELATED APPLICATIONS

The present application claims the benefit of Lanigan, Sr. et al., U.S. provisional patent application Ser. No. 62/288,248, filed on Jan. 28, 2016, and entitled “Lift Beam System.” The entire contents of this application are incorporated herein by reference.

### FIELD OF THE DISCLOSURE

The present subject matter relates to the transfer and storage of cargo involved in intermodal transportation, and more particularly, to the loading and unloading of shipping containers on a chassis.

### BACKGROUND

Under today's standards, goods are often transported from one location to another via an intermodal transportation system that combines shipment by air, sea, rail, and land. To facilitate the shipment of goods between one form of transportation and another, goods are shipped in containers that can be loaded on container ships, truck chassis, and rail cars. The efficient loading and unloading of containers, and the storage of containers therebetween, is a goal of an intermodal transportation system.

For these and other reasons, a lift beam system for loading, unloading, and storing containers would be an important improvement in the art.

### SUMMARY

According to one aspect, a system for handling shipping containers comprises first and second lift beams, first and second support beams, and a plurality of vertical beams wherein the plurality of vertical beams are connected by the first and second lift beams and the first and second support beams. The lift beam system according to this aspect further includes first and second pluralities of lifting pads disposed respectively on each of the first and second lift beams wherein the lifting pads of the first and second pluralities are arranged to have an initial position recessed within the respective lift beam on which each lifting pad is disposed and the lifting pads of the first and second pluralities are arranged to have a deployed position distal to the respective lift beam on which each lifting pad is disposed. Further still, the lift beam system comprises first and second pluralities of swivel feet disposed respectively on each of the first and second support beams and a lift beam driving mechanism that raises and lowers the first and second lift beams.

According to another aspect, a system for raising and lowering shipping containers comprises at least one lift beam having a plurality of lifting pads disposed therealong, at least one support beam having a plurality of swivel feet disposed therealong, a lower containment cavity, and an upper containment cavity wherein the at least one lift beam moves between a first position in the lower containment cavity and a second position in the upper containment cavity. Furthermore, in accordance with this aspect the plurality of lifting pads and the plurality of swivel feet are configured to transfer a container therebetween when the lift beam is at the second position, the plurality of lifting pads have a first initial position and a first deployed position, and the plurality of swivel feet have a second initial position and a second deployed position such that the plurality of lifting pads and the plurality of swivel feet are configured to support the container in the first and second deployed positions, respectively.

Other aspects and advantages will become apparent upon consideration of the following detailed description and the attached drawings wherein like numerals designate like structures throughout the specification.

### BRIEF DESCRIPTION OF THE DRAWINGS

FIGS. 1A-1G are an isometric view of a lift beam system in various stages of operation during which a container is hoisted from a lower containment cavity to an upper containment cavity;

FIGS. 2A-2D are an elevational view of the lift beam system in various stages of operation during which the container is hoisted from the lower containment cavity to the upper containment cavity;

FIGS. 3A-3B are a partial isometric view of one side of the lift beam system in various stages of operation during which the container is hoisted from the lower containment cavity;

FIGS. 4A-4B are an isometric view of a single deployed lifting pad before and after engagement of the lifting pad with the container;

FIGS. 5A-5D are a perspective view of a horizontal support beam on one side of the lift beam system including the swivel feet mounted thereto and said swivel feet in various stages of deployment;

FIGS. 6A-6D are a rear perspective view of the lift beam system as the lift beams return to the initial position of the lift beams after the container has been hoisted to the upper containment cavity;

FIGS. 7A-7E are a perspective view of a single side of the lift beam system;

FIGS. 8A-8D are an isometric view of a single lifting pad and lifting pad recess in various stages of deployment;

FIGS. 9A-9C are a cross-sectional view of a single lifting pad and lifting pad recess in various stages of deployment;

FIGS. 10A-10E are isometric views from different angles of a single lifting pad and lifting pad recess with the stationary recess housing removed in various stages of deployment; and

FIGS. 11A-11G are isometric views from different angles of a single lifting pad and lifting pad recess with the stationary recess housing removed and support structures shown as transparent during which the lifting pad is in various stages of deployment.

### DETAILED DESCRIPTION

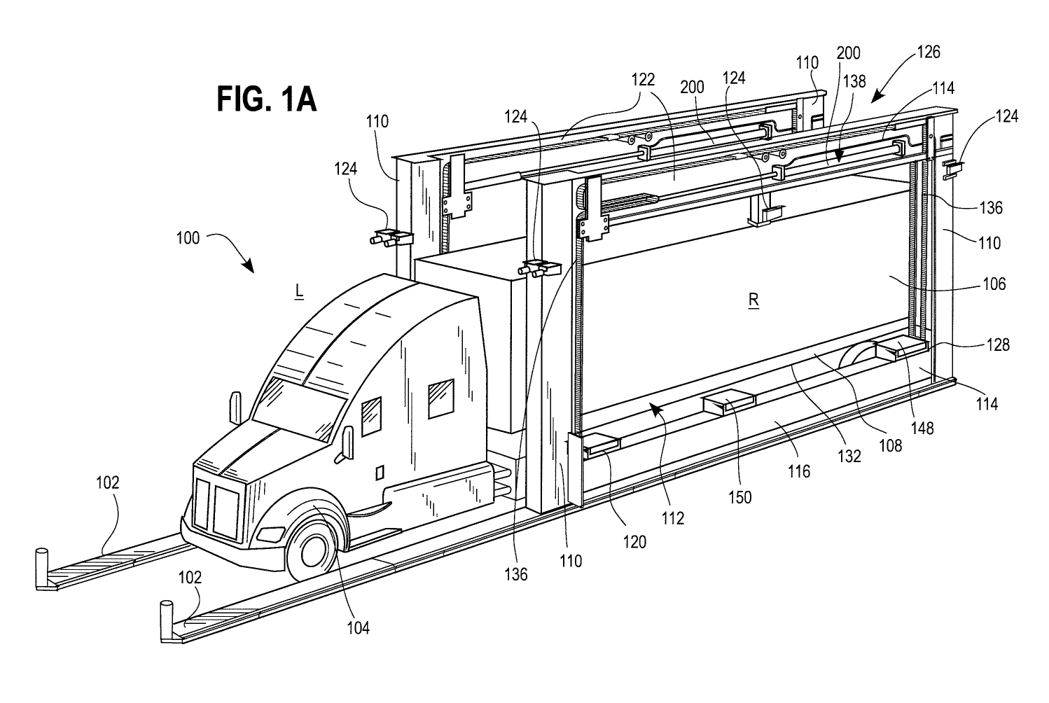

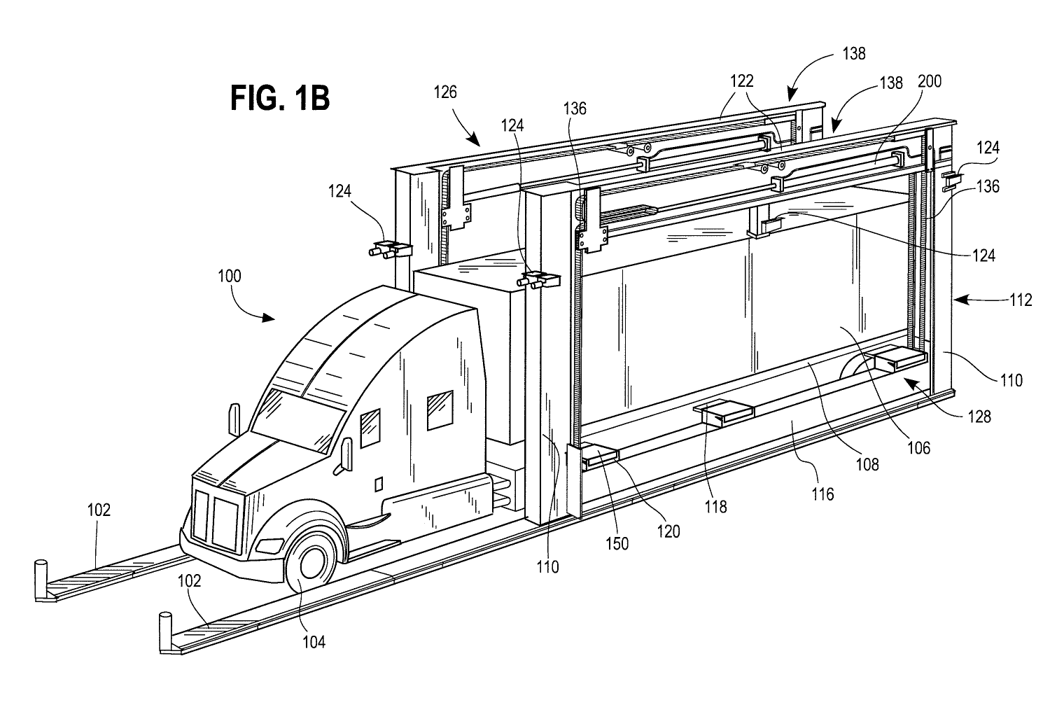

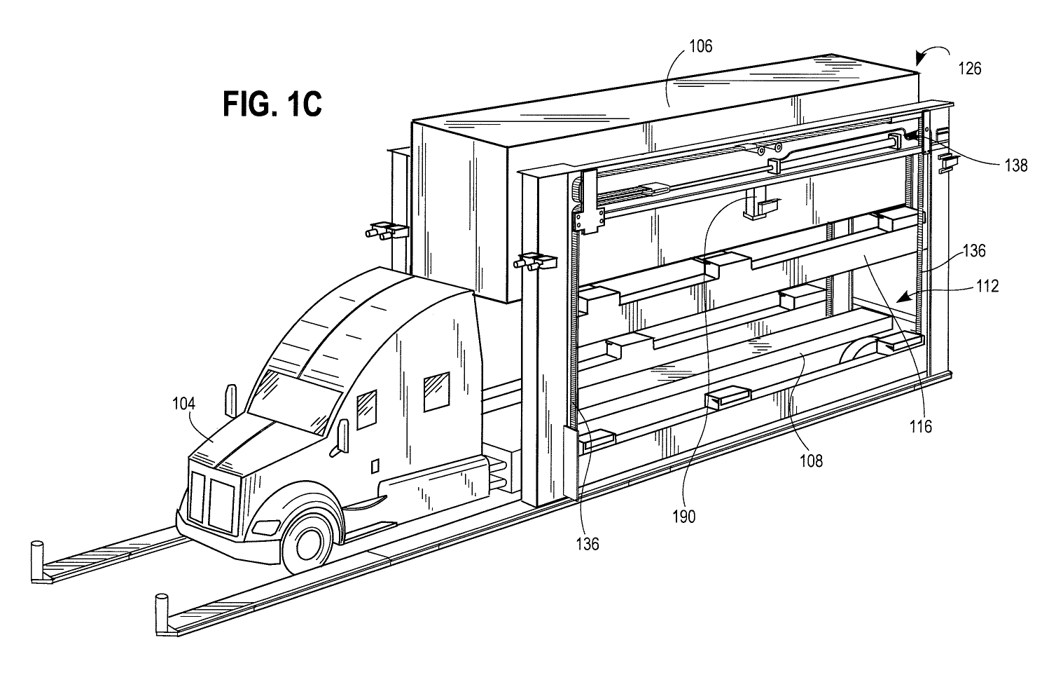

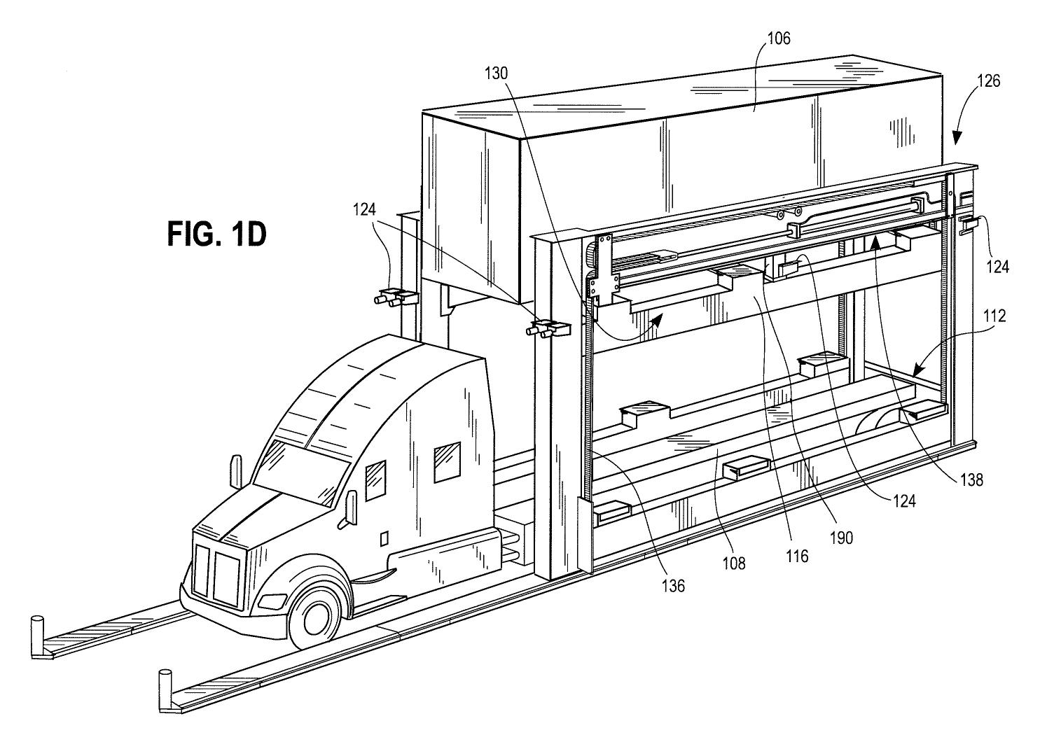

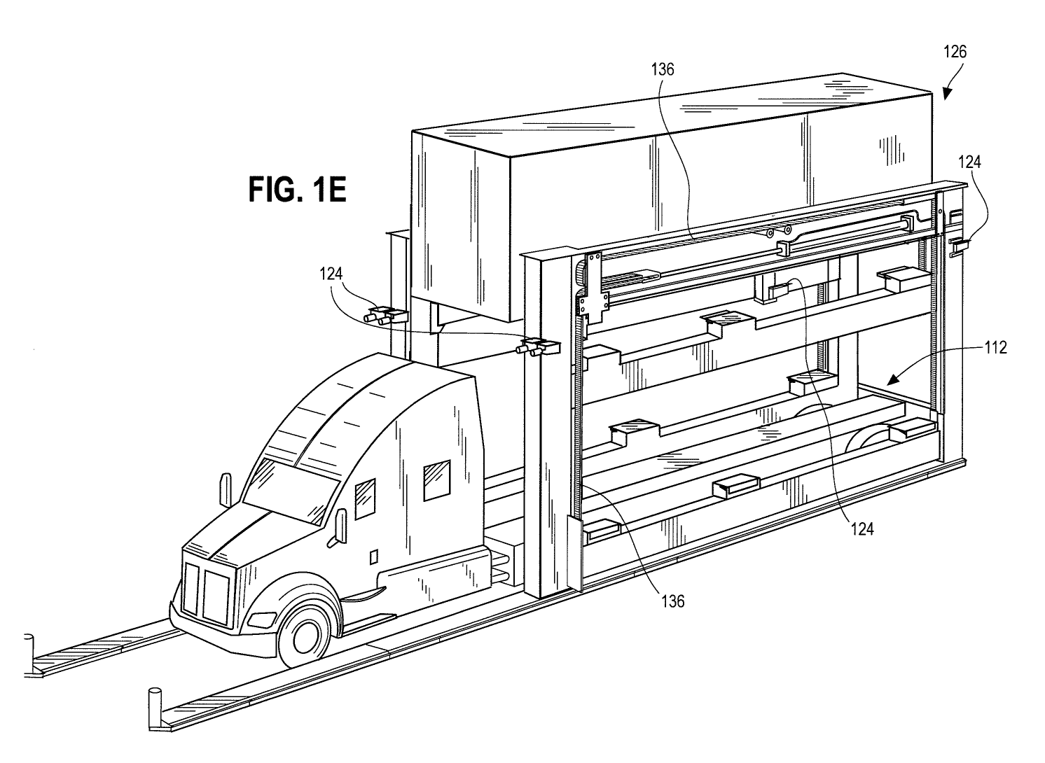

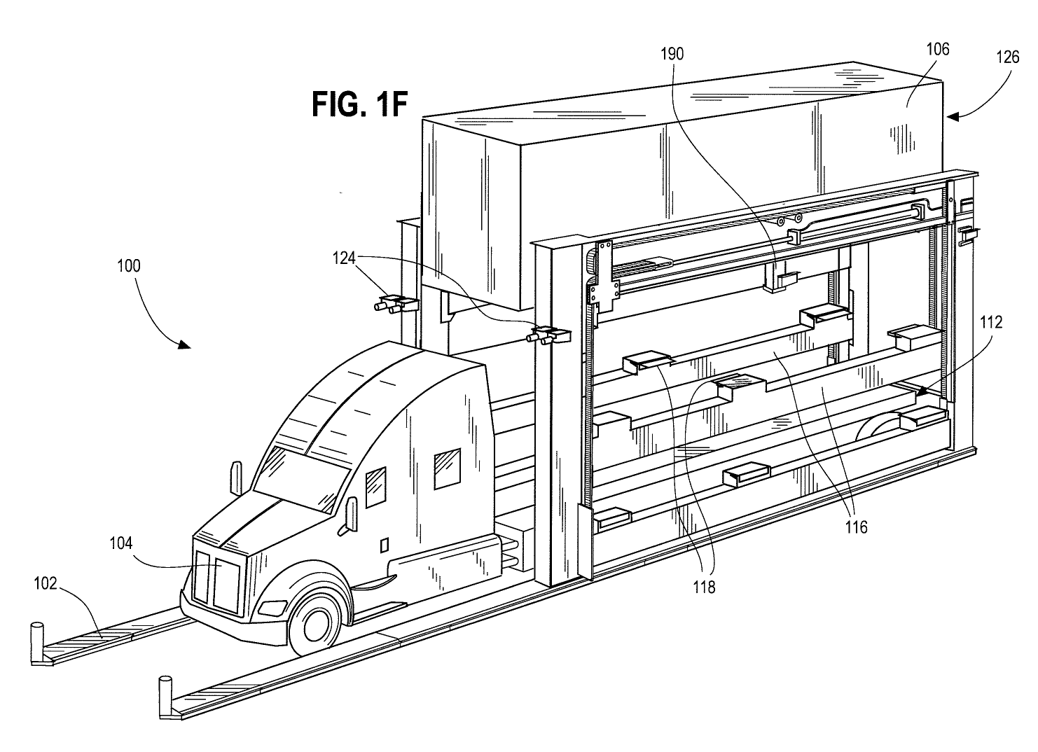

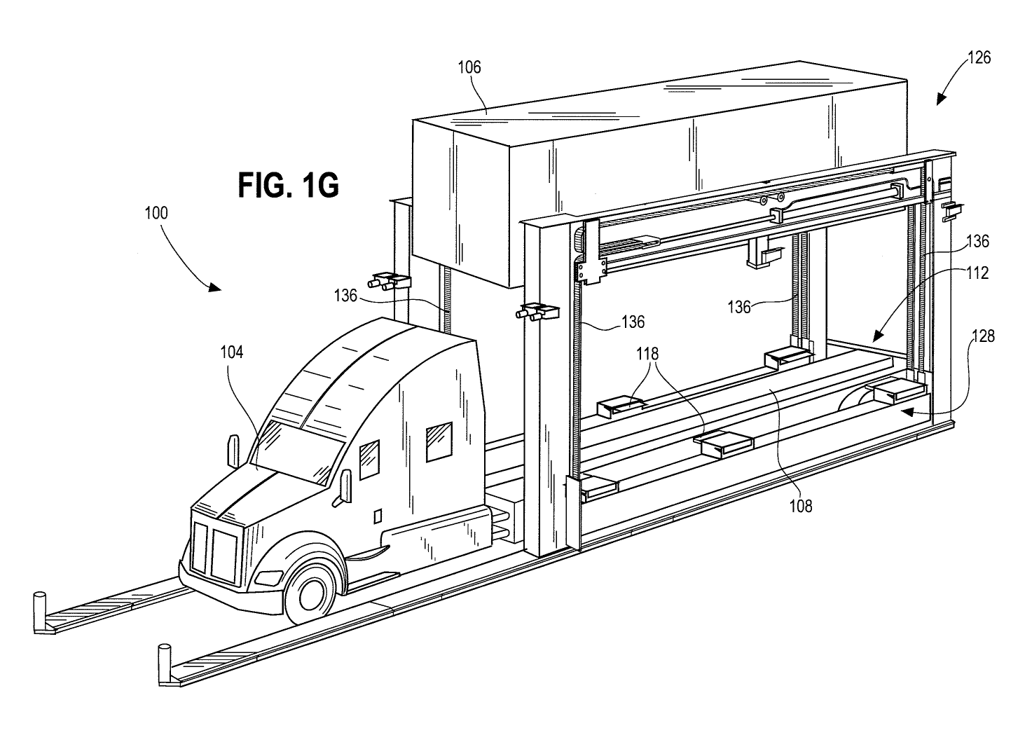

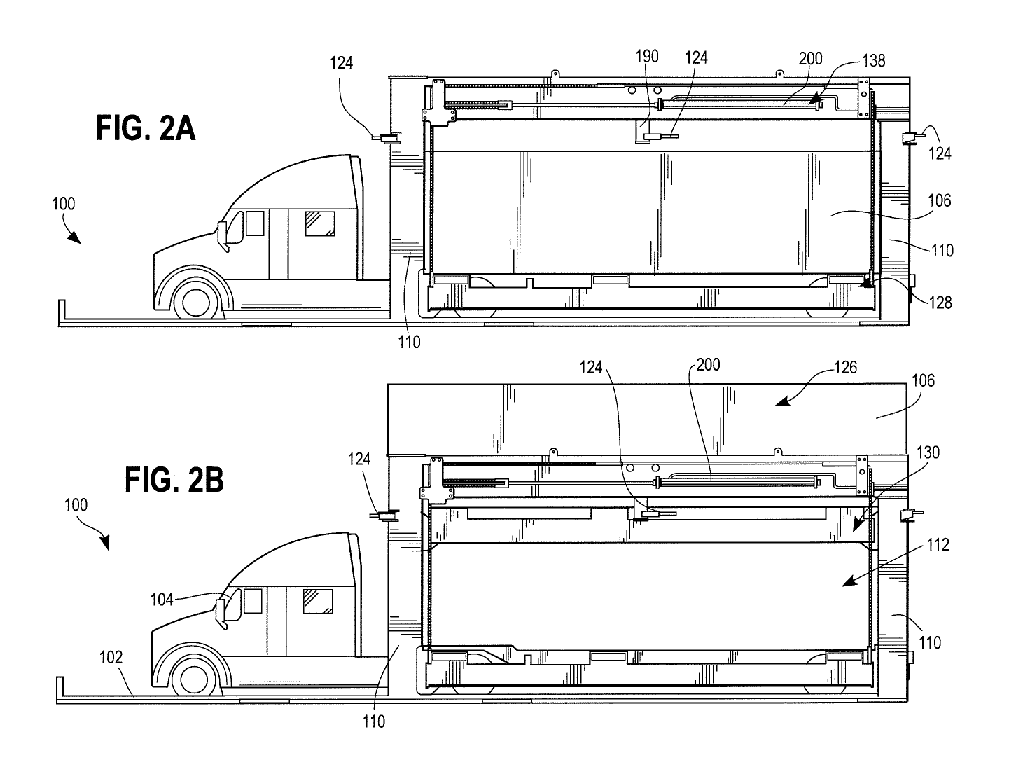

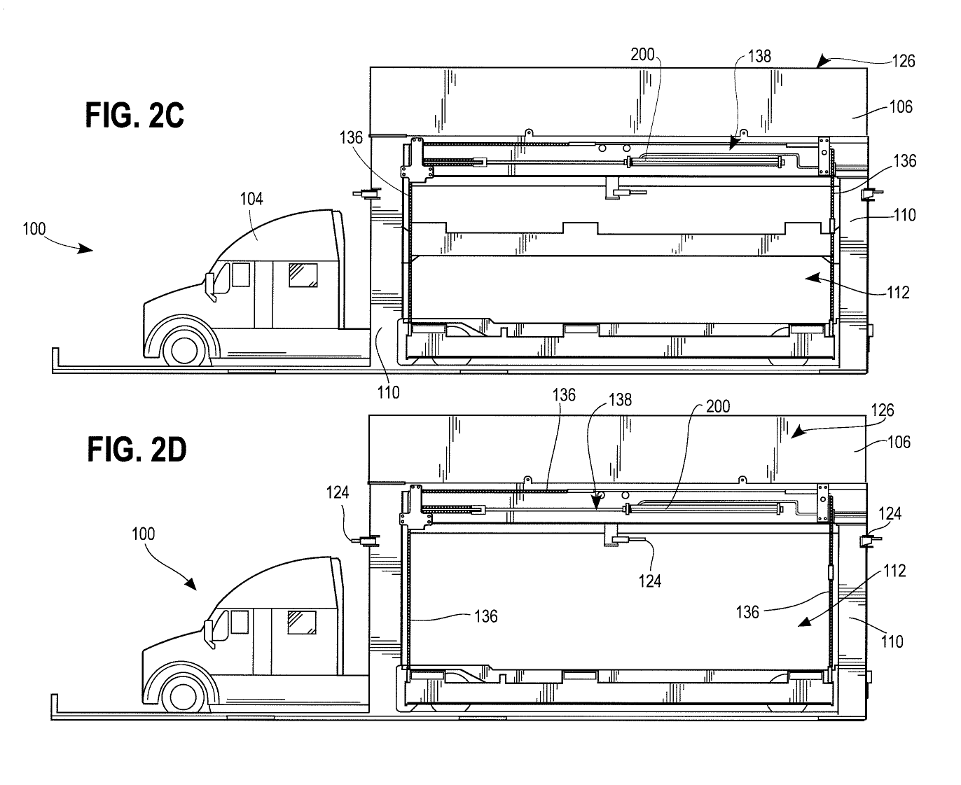

Referring to FIGS. 1A-1G and 2A-2D, a lift beam system 100 for transferring and storing shipping containers is shown in varying stages of operation. The lift beam system 100 is shown in FIGS. 1A-1G in combination with an automatically aligning chassis guide system 102, a tractor-trailer 104, and a shipping container 106. FIGS. 1A-1G depict an isometric view of the lift beam system 100 as the container 106 is removed from the tractor-trailer chassis 108, hoisted, and stored. FIG. 2A further depicts an elevational view of the lift beam system 100 as the container 106 is removed from the tractor-trailer chassis 108, hoisted, and stored.

The lift beam system 100 includes four vertical beams 110 arranged around a lower containment cavity 112 that the container 106 may occupy. Two vertical beams 110 are arranged on either side of the lower containment cavity 112. Horizontal beams 114 run parallel to the lower containment cavity 112. Two horizontal beams 114 are provided on either side of the cavity 112. The first set of two horizontal beams 114 connects the vertical beams 110 present on the first side (L) of the lift beam system 100 and the second set of horizontal beams 114 connects the vertical beams 110 present on the second side (R).

The bottom horizontal beam 114 on each side is configured to function as a lift beam 116. Each lift beam 116 includes lifting pads 118 and lifting pad recesses 120. In an example configuration, each lift beam 116 has three lifting pads 118 arranged to face the lower containment cavity 112 when deployed. The top horizontal beam on each side is configured to be a support beam 122. Each support beam 122 has swivel feet 124 that may be utilized to store the container 106 in an upper containment cavity 126 formed between the support beams 122. Generally, the lift beams 116 are arranged to lift the container 106 from the lower containment cavity 112 to the upper containment cavity 126 where the container 106 may be stored on the swivel feet 124. The lift beam system 100 performs this function by deploying lifting pads 118 under the container 106 and hoisting the lift beam 116, with the container 106 carried thereon, from an initial, bottom position 128 to a second, top position 130.

Referring now specifically to FIGS. 1D-1G and 2C-2D, the lift beams 116 are depicted as retracting from the top position 130 while ceasing to carry the container 106 on the lifting pads 118. The container 106 is retained in the upper containment cavity 126 by the swivel feet 124 located along the length of each upper support beam 122.

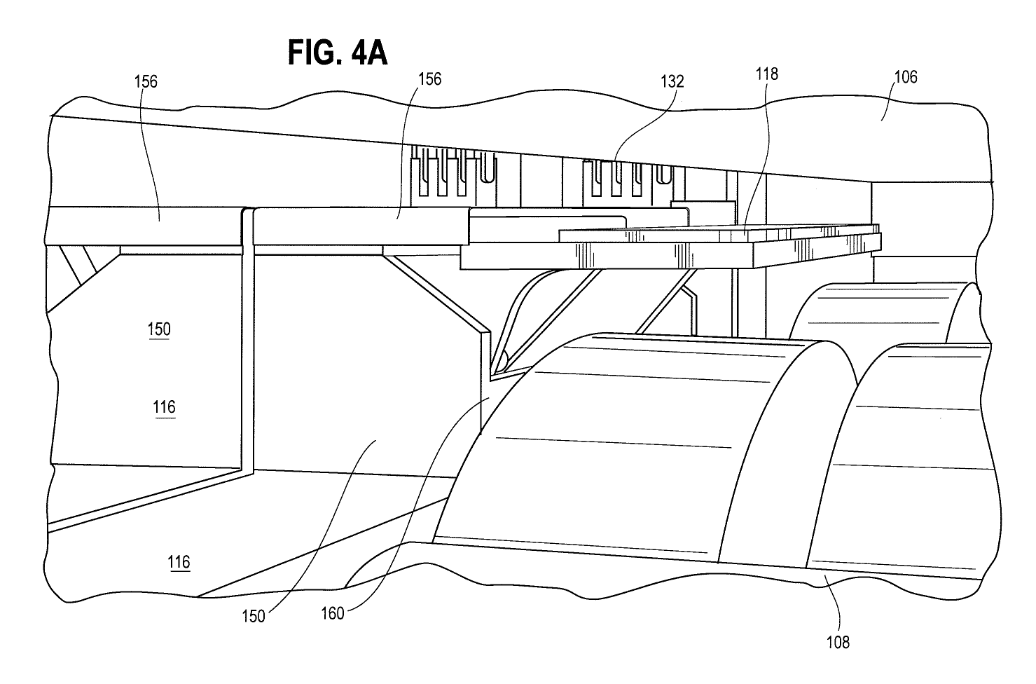

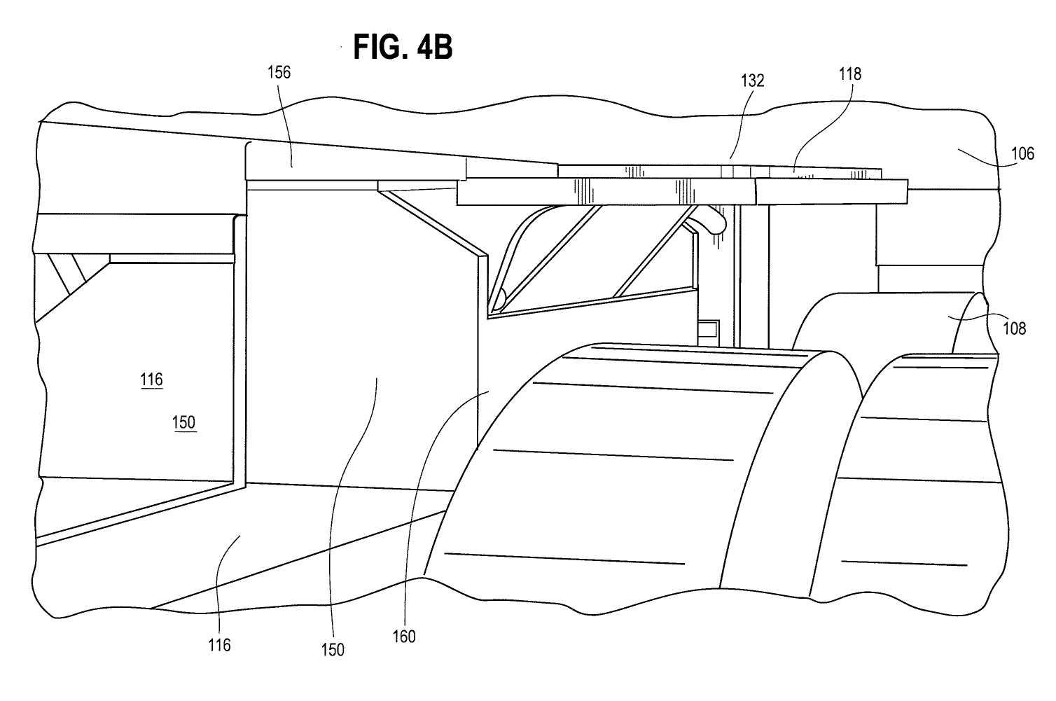

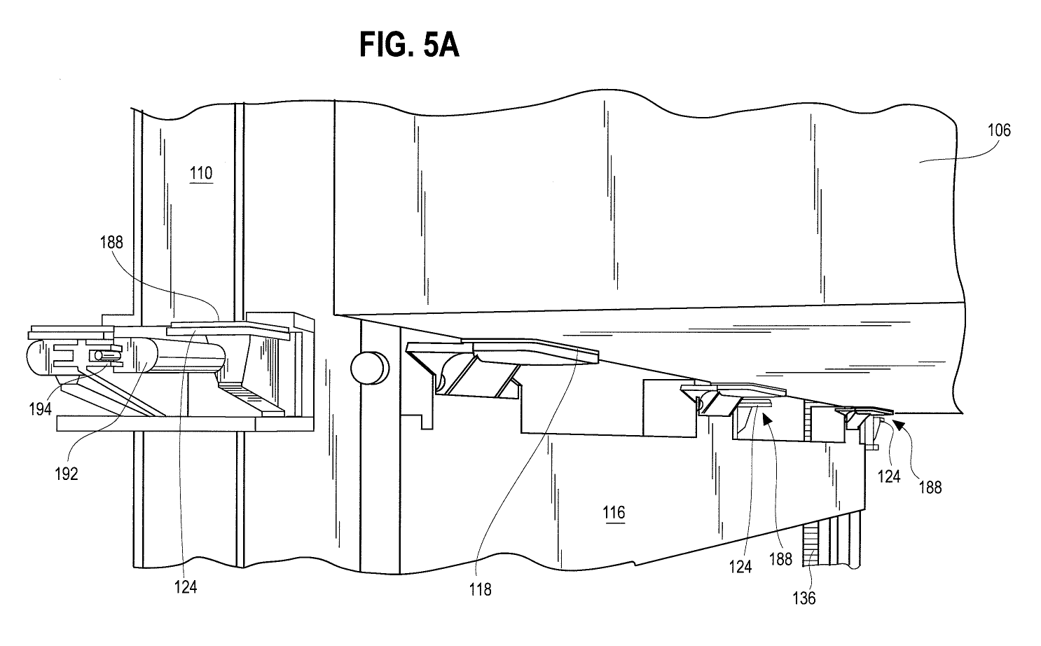

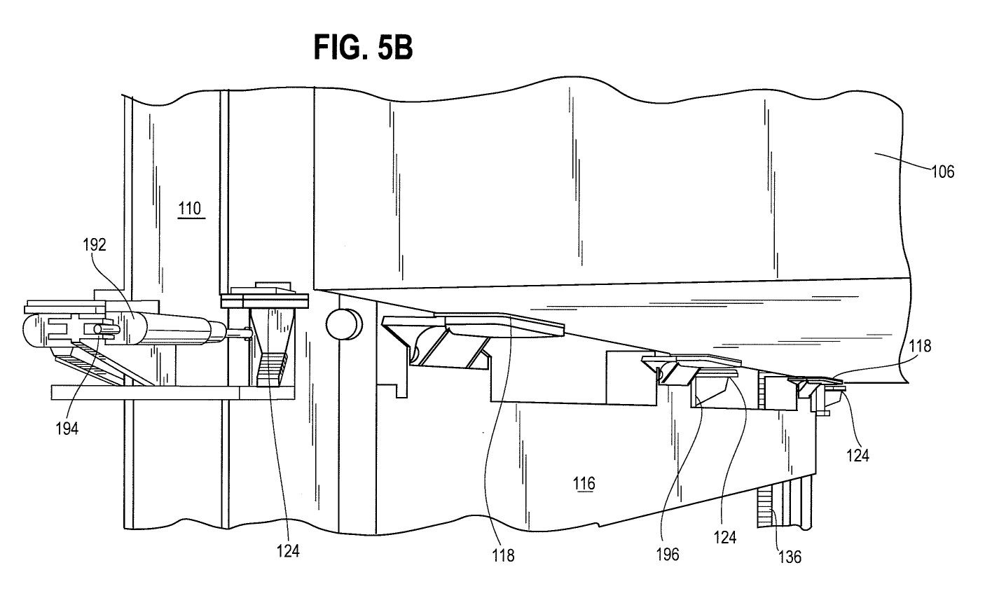

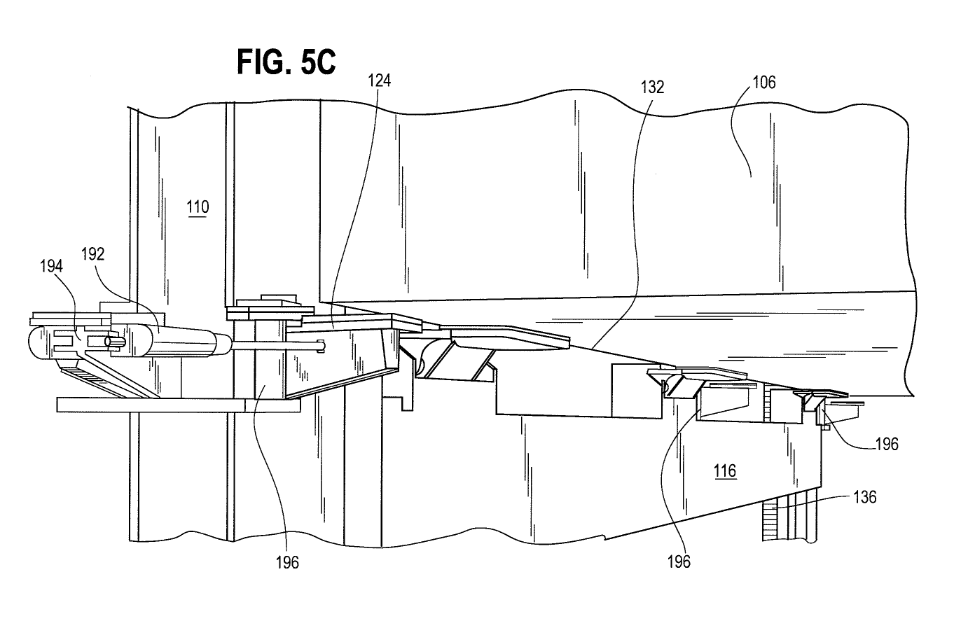

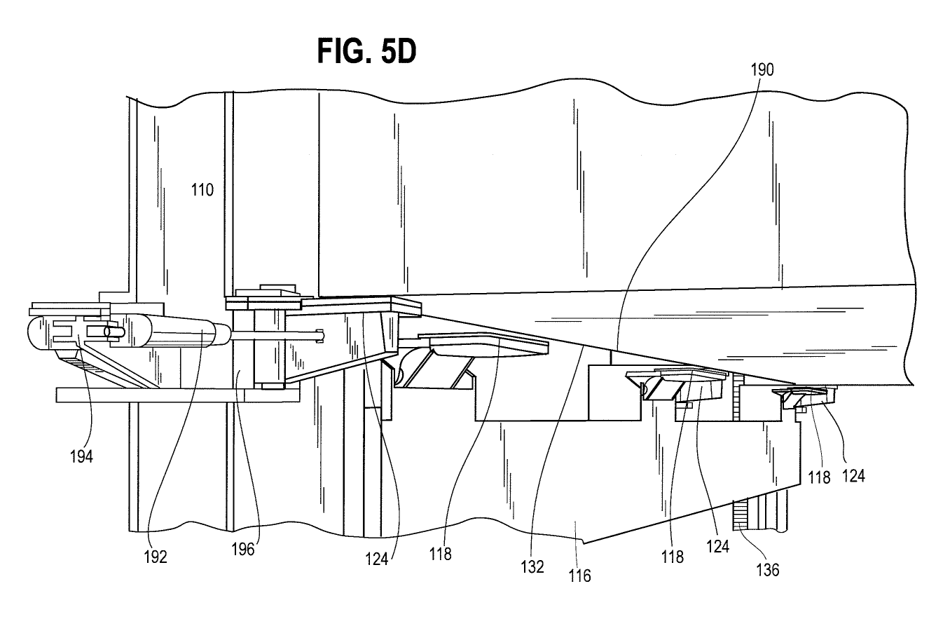

In order to engage the container 106, the lifting pads 118 and swivel feet 124 contact bottom edges 132 of the container 106 along either side of said container 106, such as aligned with the corner castings of the container. Proper alignment of the container 106 may increase the effectiveness and reliability of the lifting pads 118 and swivel feet 124 by ensuring proper engagement with the bottom edge 132 of the container 106. Likewise, alignment of the tractor-trailer chassis 108 that introduces the container 106 into the lower containment cavity 112 may assist in the proper engagement of the lifting pads 118 and swivel feet 124 with the edge 132 of the container 106. The container 106, while resting on the chassis 108, is slightly below the lower containment cavity 112. Referring ahead to FIGS. 4A and 4B, the engagement of an individual lifting pad 118 with the bottom edge 132 of the container 106 is shown in a close-up view. Further, referring ahead to FIGS. 5A-5D, the engagement of the swivel feet 124 with the bottom edge 132 of the container 106 is shown in a close-up view of one side of the lift beam system 100.

As shown in FIGS. 1A-1G and 2A-2D, an example embodiment of the lift beam system 100 may be used in combination with the automatically aligning chassis guide system 102, such as the system described in U.S. patent application Ser. No. 14/856,290, filed on Sep. 16, 2015, titled “AUTOMATICALLY ALIGNING CHASSIS GUIDES.” Alternatively, stationary tire guides or other methods/devices for aligning the chassis 108 of the tractor-trailer 104 may be used to improve alignment of the container 106 with the lift beam system 100.

In example embodiments, sensors in the lower containment cavity 112 may detect the positioning of the chassis 108 in the bay as well as whether or not the chassis 108 is carrying a container. The sensors may be used in conjunction with the automatically aligning chassis guide system 102 or may be configured as part of the lift beam system 100. The operation of the container yard, of which the lift beam system 100 is a part, may have software controls that automatically activate the lift beam system 100 based on inbound or outbound status of the tractor-trailer 104. Further, the lift beam system 100 may be compatible with transfer management software that indicates to the tractor-trailer 104 a particular bay to enter, and verifies that the tractor-trailer is at the proper location once the chassis 108 has been positioned. Additionally, security software may be combined with the lift beam system 100 such that the driver may have to enter a code or swipe a card to activate the system. Alternatively, the lift beam system 100 may be activated by a push button control.

In further alternative embodiments, the lift beam system 100 may be used in combination with other methods for transporting shipping containers 106. For example, the lift beam system 100 may be used with railroad tracks for the transfer of shipping containers from the well of a railroad car to the upper containment cavity 126. In an alternative example, the lift beam system 100 may be used alongside a port such that shipping containers are transferred/moved by other means such as by crane, forklift, or another towing method for ISO shipping containers.

Additionally, referring again to the example embodiment shown in FIGS. 1A-1G and 2A-2D, the tractor-trailer 104 transports the chassis 108 and shipping container 106 into a position slightly below the lower containment cavity 112 while the lifting pads 118 are retracted in an initial, recessed position 134 and the lift beam 116 is in the bottom, initial position 128. Then, once the lifting pads 118 have deployed and engaged the bottom edges 132 of the container 106, the chassis 108 may be removed at any time or retained underneath the lower containment cavity 112, perhaps for reloading with another container. Alternatively, upon completion of the lifting of the container 106 and placement of the container 106 on the swivel feet 124 for storage, another chassis may enter into the lift beam system 100 and the container 106 may be lowered on to this next chassis.

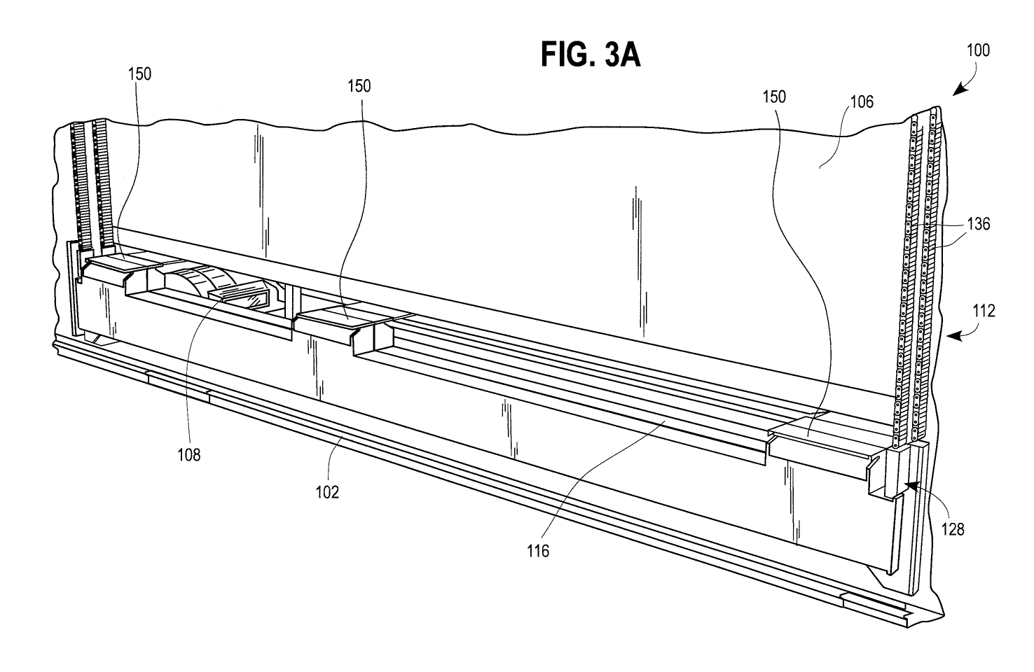

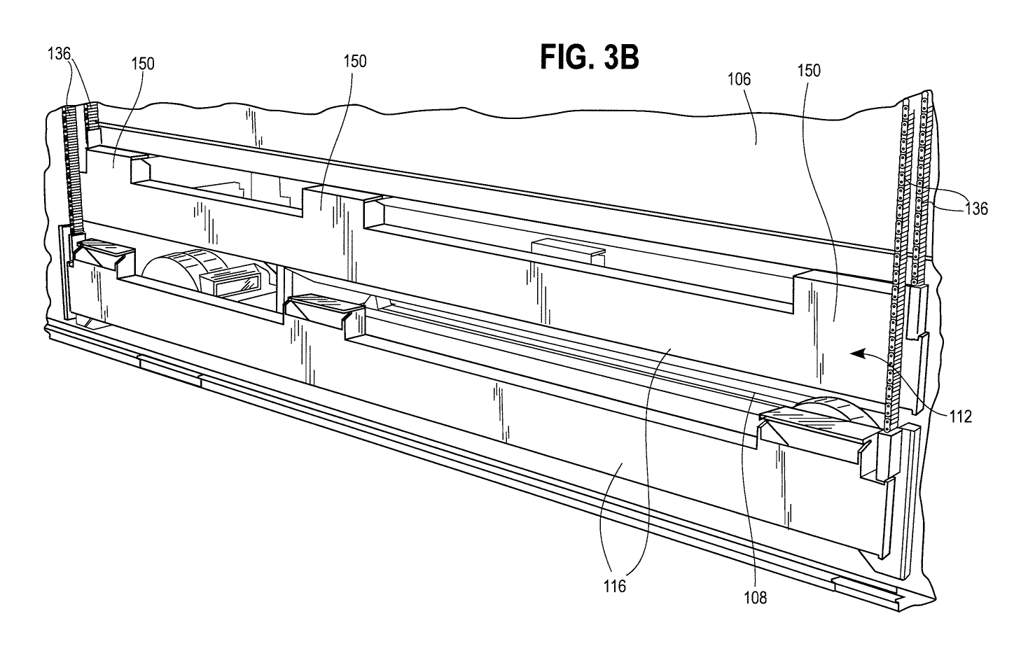

As shown in FIGS. 3A and 3B, a lifting chain 136 runs along the height of each vertical beam 110. A driving mechanism 138 for each lifting chain 136 may be located within or along the vertical beams 110. Alternatively, the driving mechanism 138 for the lifting chains 136 may be housed within the structural support beams 122 coupling the vertical beams 110 on each side of the lift beam system 100. The lifting chains 136 may have individual driving mechanisms or a combined driving mechanism 138 for operating both of the lifting chains 136 arranged on a single side (L or R).

Referring again to FIGS. 1A-1G and 2A-2D, in the example embodiment shown, the driving mechanism 138 includes a hydraulic lift cylinder 200 that gathers the lifting chain 126 on a single side of the lift beam system 100. The lifting chain 126 may be gathered within the support beam 122 on each respective side. A cylinder for rotary collection of the lifting chains 126 as well as large rollers for aligning the lifting chains 126 with said cylinder, or another method of storing the lifting chains 126, may be included within the support beam 122. The driving mechanism 138 may instead include a linear actuator such as a ball screw-type actuator or another suitable configuration for cycling the lift chain 126 and hoisting the lift beam 116.

In the example embodiment shown in FIGS. 3A and 3B, each lift beam 116 has three lifting pads 118 disposed on the interior side of the lift beam 116, as discussed above. Similarly, along with each lifting pad 118, a recess 120 is integrally incorporated into the lift beam 116 for storage of the lifting pads 118 when a lifting action is not being performed. The lifting pads 118 are deployed and retracted by individual lifting pad driving mechanisms 140. In example embodiments, each lifting pad 118 is coupled with a linear actuator 142, a hydraulic cylinder, a pneumatic actuator, or another engine for positioning the lifting pad 118 and actuating the lifting pad driving mechanism 140. Further, each lifting pad 118 is held in place by a pivot mounting 144. In an example embodiment, the pivot mounting 144 connects the linear actuator 142, the lifting pad 118, and the bottom panel 146 of the lifting pad recess 120. Further, each lifting pad driving mechanism 140 is arranged to couple with one or more moveable panels 148 of a recess housing 150.

Referring now to FIGS. 5A-5D, the container 106 is shown as having been hoisted into the upper containment cavity 126. The container is then stored on the swivel feet 124 of the support beams 122 and/or vertical beams 110. As mentioned above, the container 106 may be stored in the upper containment cavity 126 until a new chassis enters the lift beam system 100 or otherwise. Alternatively, the container 106 may be removed from the upper containment cavity 126 by a crane or another method of transferring shipping containers.

Referring still to FIGS. 5A-5D, the swivel feet 124 on one side of the lift beam system 100 are shown during varying stages of deployment. During the hoisting of the container, the swivel feet 124 are retained in an initial, tucked position 188 that does not encroach upon the upper containment cavity 126. In the example embodiment shown here, three swivel feet 124 are arranged on each side of the lift beam system 100 alongside the upper containment cavity 126. Alternatively, fewer swivel feet 124 or more swivel feet 124 may be arranged along each side of the upper containment cavity 126, or along the front and back of the lift beam system 100. Further in this embodiment, the swivel feet 124 are structurally supported by the vertical beams 110 for the corner swivel feet 124A of the lift beam system 100, and by an extended portion 190 of the support beams 122 for the middle swivel feet 124B. In an alternative example embodiment, the middle swivel feet 124B may be omitted, or additional middle swivel feet 124B may be added along the length of the support beam 122.

Each of the swivel feet 124 is actuated by a dedicated horizontal linear actuator 192. Each horizontal linear actuator 192 is connected to the vertical beam 110 or support beam 122 by a hinged base 194. Further, each horizontal linear actuator 192 shifts horizontally when actuated in order to deploy an associated swivel foot 124. This example embodiment depicts the electric linear actuator 192, but an alternative mechanism may be used to position the swivel feet 124 such as a hydraulic cylinder, a pneumatic actuator, or any other suitable actuator. Further, each electric linear actuator 192 may include limit switches for controlling the stroke length of the actuator. Control logic may make use of limit switches and known stroke length for accurate positioning of the swivel feet 124. Each swivel foot 124 is also connected to the vertical beam 110 or support beam 122 by a pin hinge 196. Thus, each swivel foot 124 swings on the respective pin hinge 196 from the initial, tucked position 188 to a deployed position 198 extending into the upper containment cavity 126, and vice versa.

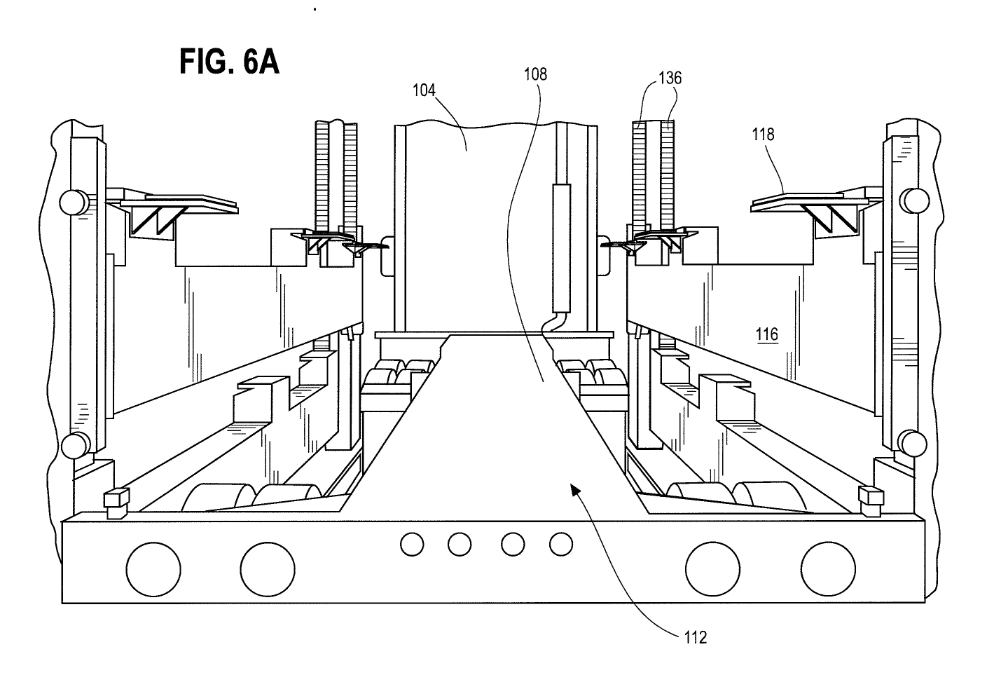

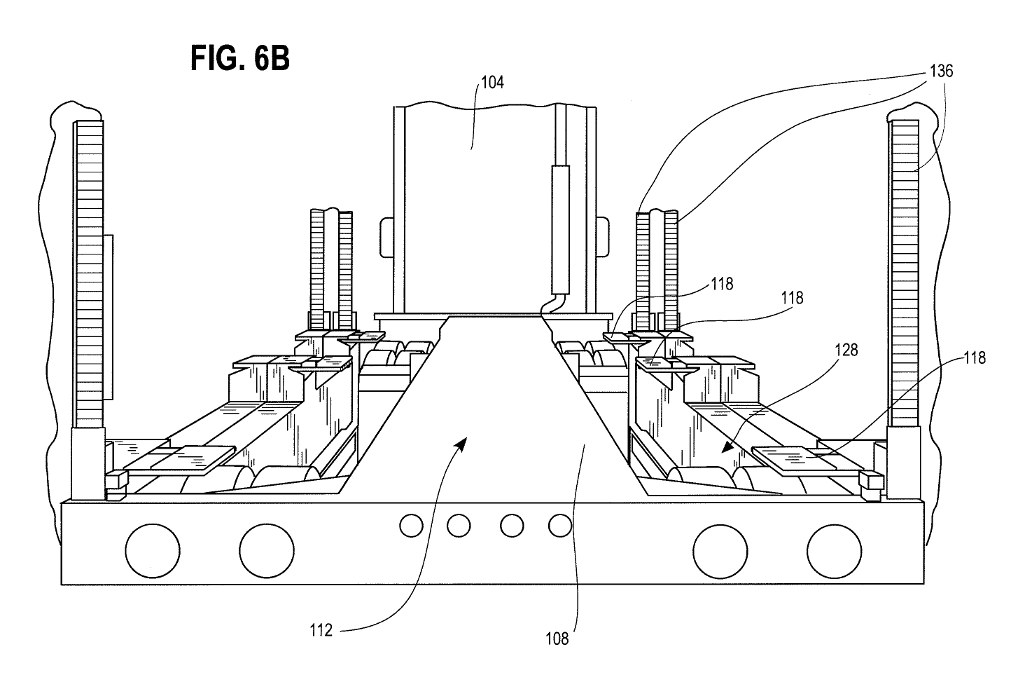

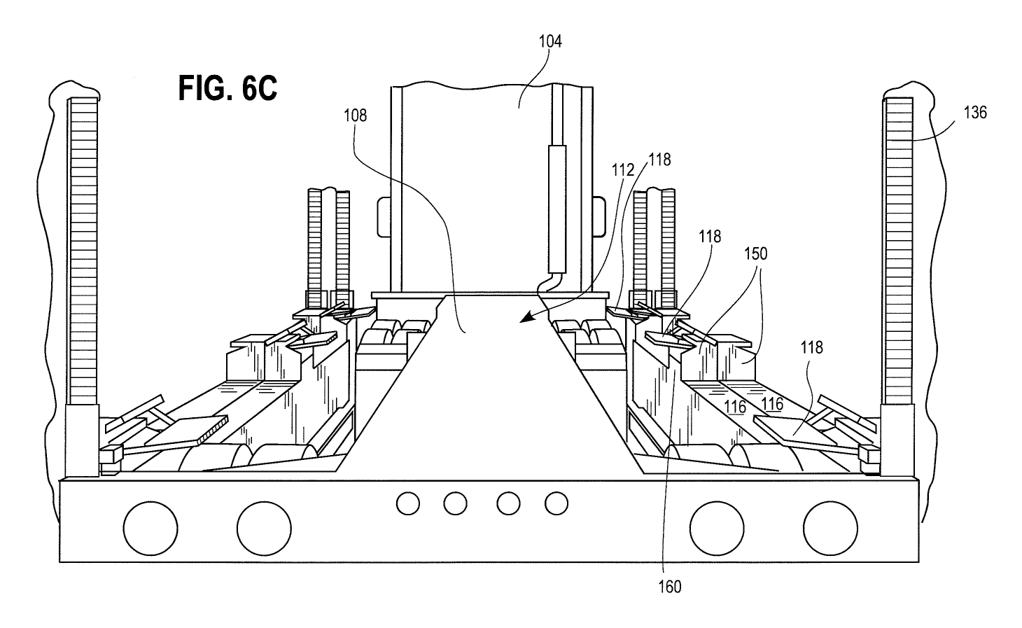

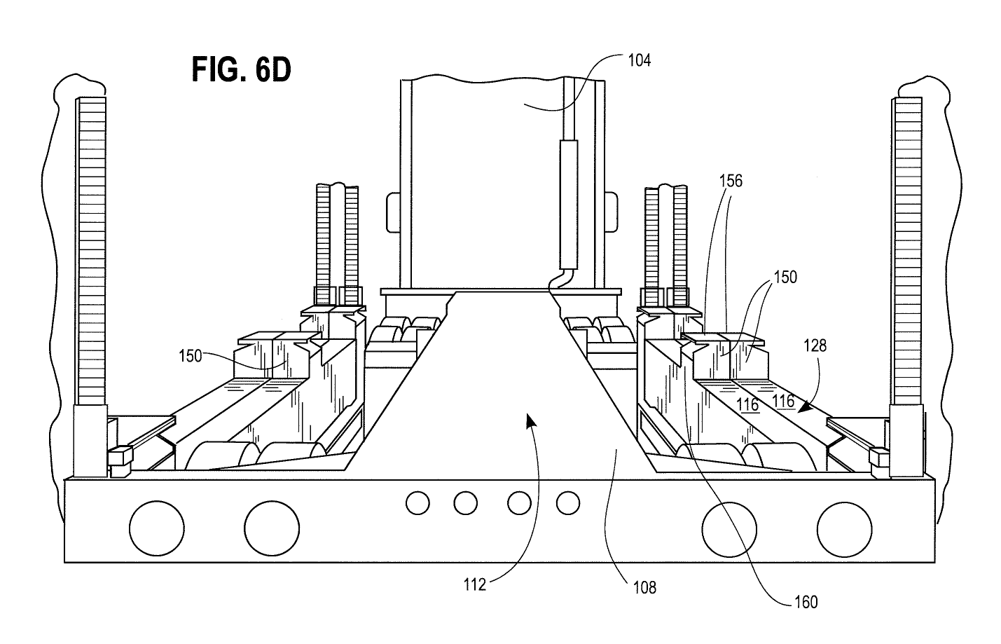

Referring back to FIGS. 1E-1G, 2C, and 2D the lift beams 116 revert to the initial, bottom position 128 after depositing the container on the swivel feet 124 in the upper containment cavity 126. The lift beams 116 are seen specifically in FIGS. 6A-6D, completing the motion from the second, top position 130, back to the initial, bottom position 128. Each lift beam 116 returns to the initial position 128 before retracting the lifting pads 118 from the fully deployed position 152 distal to the lifting beam 116 back to the initial, recessed position 134 of the lifting pads 118 within the recess housing 150.

FIGS. 6A-6D further show how lift beams 116 from the first lift beam system 100 may align with lift beams 116 from another lift beam system arranged immediately beside the first system 100. The lift beam system 100 may be structurally repeated in side-by-side containment cavities such that some components may be shared. In an example embodiment of the lift beam system 100 used in conjunction with a neighboring lift beam system, the two systems may share vertical beams 110, portions of the chassis guide system 102, mounting plates for the system, or the lifting beam driving mechanism 138. However, a typical embodiment of the lift beam system 100 may include two separate lift beam driving mechanisms. Further still, plural lift beam systems 100 may be arranged in a bay style configuration.

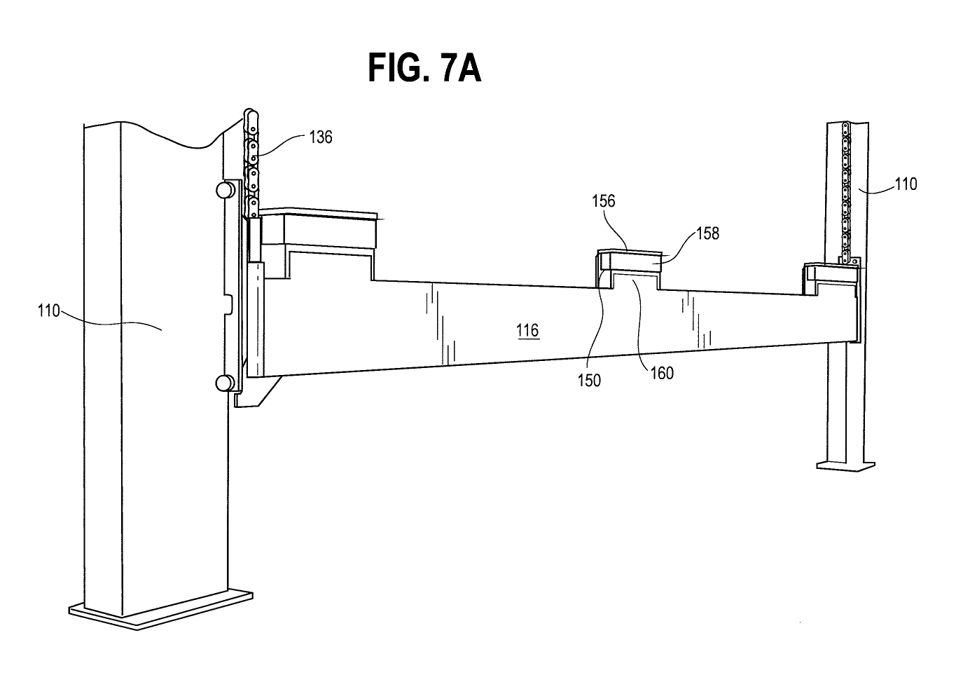

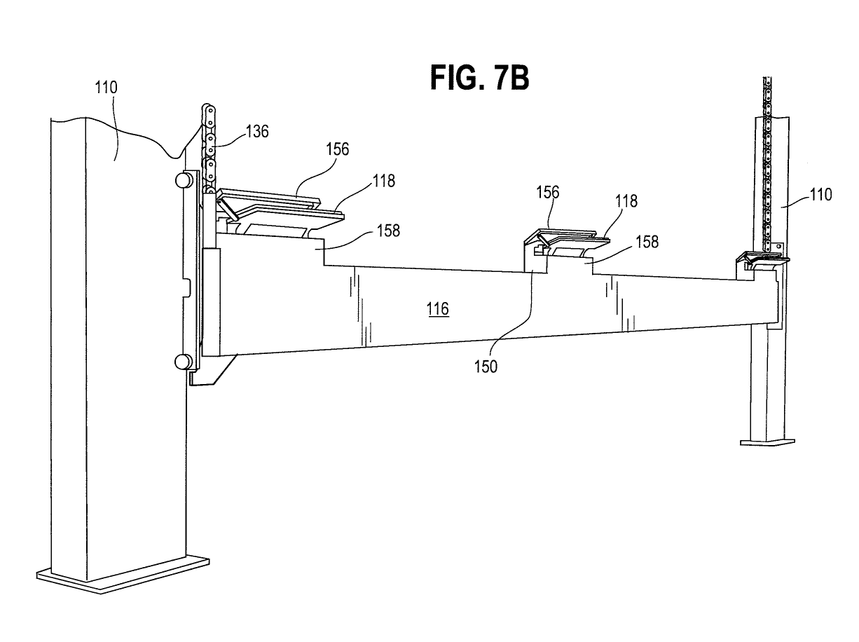

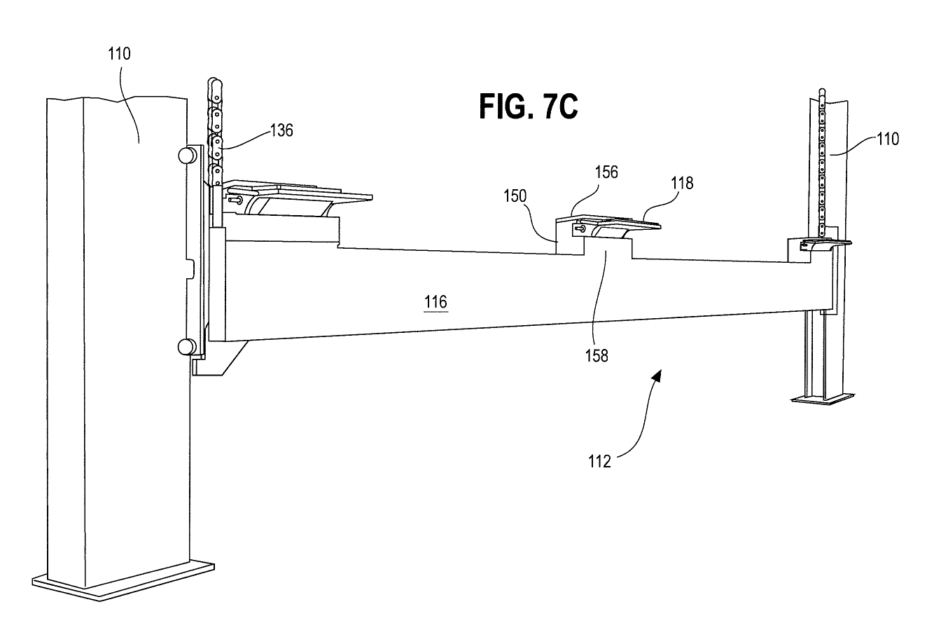

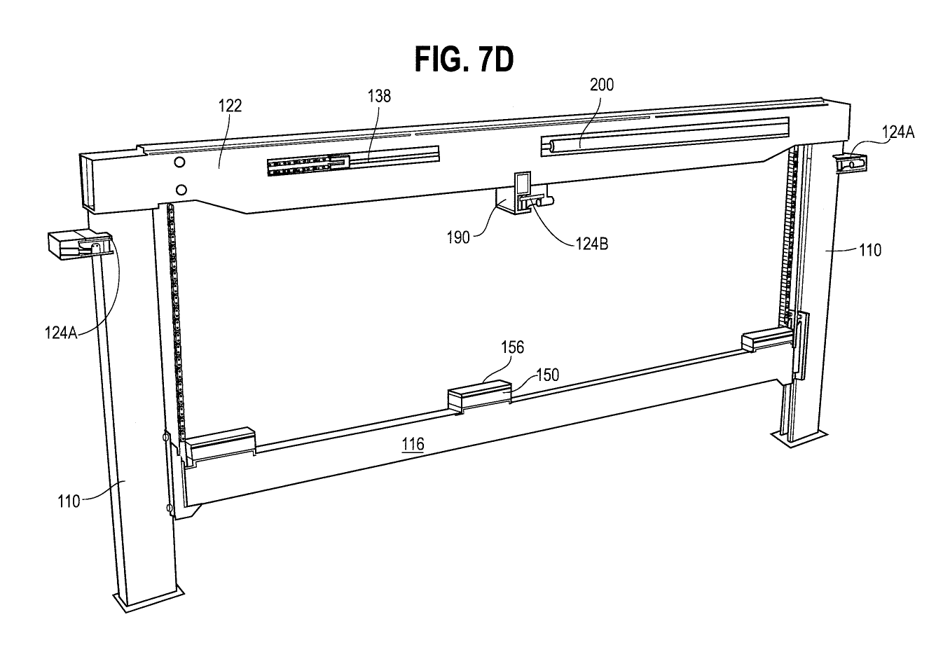

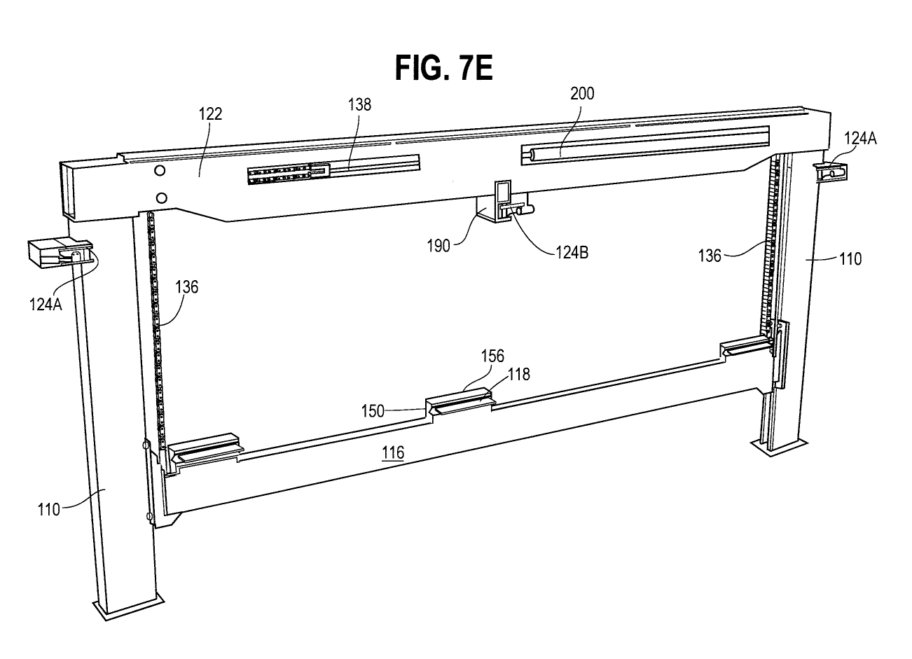

Referring now to FIGS. 7A-7E, the lifting beam 116 is shown along with the lifting pad recess housing 150 for each lifting pad 118 and lifting pad mechanism 140 spread along the length of the lift beam 116. In the example embodiment shown, three lifting pads 118 are located at the front, center, and back of the lifting beam 116. In another example embodiment, more than three or fewer than three lifting pads 118 may be located along the length of each lifting beam 116.

As seen in FIG. 7A, in the initial, retracted position 154, the lifting pad 118 and lifting pad driving mechanism 140 are within the recess housing 150. The recess housing 150 may have one, two, or more moveable panels 148. In an example embodiment, one moveable panel 148 of the recess housing 150 forms the top panel 156 of the housing and raises up to allow the lifting pad 118 to extend up and out of the recess housing 150 to the deployed position 152. Another moveable panel 148 of the recess housing 150 forms a partial interior side panel 158 and moves slightly out and down, alongside the remaining interior side panel 160 to allow the lifting pad 118 to extend horizontally, distal to the lift beam 116 into the fully deployed position 152.

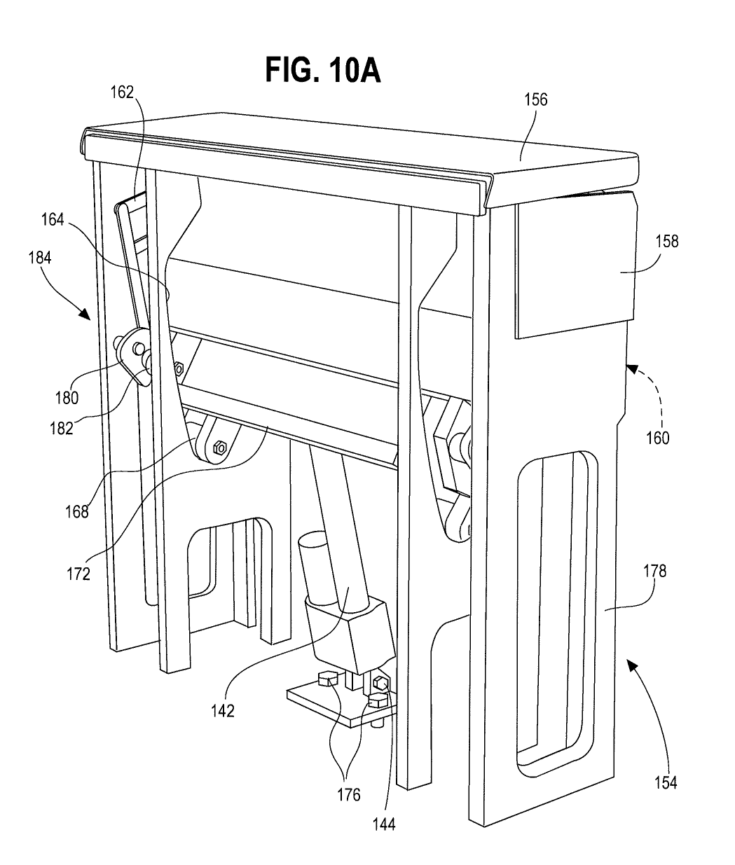

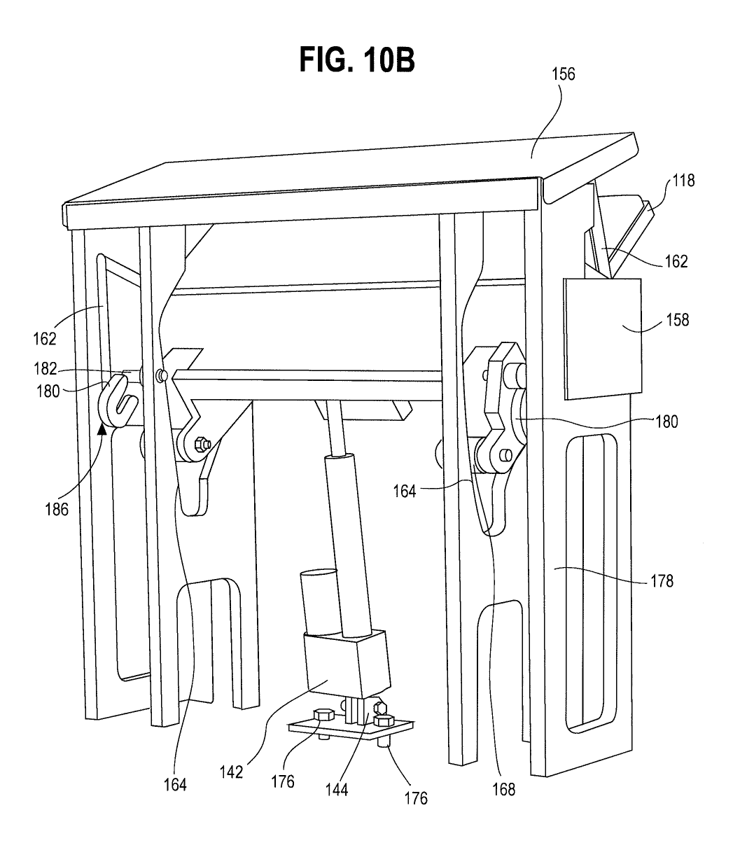

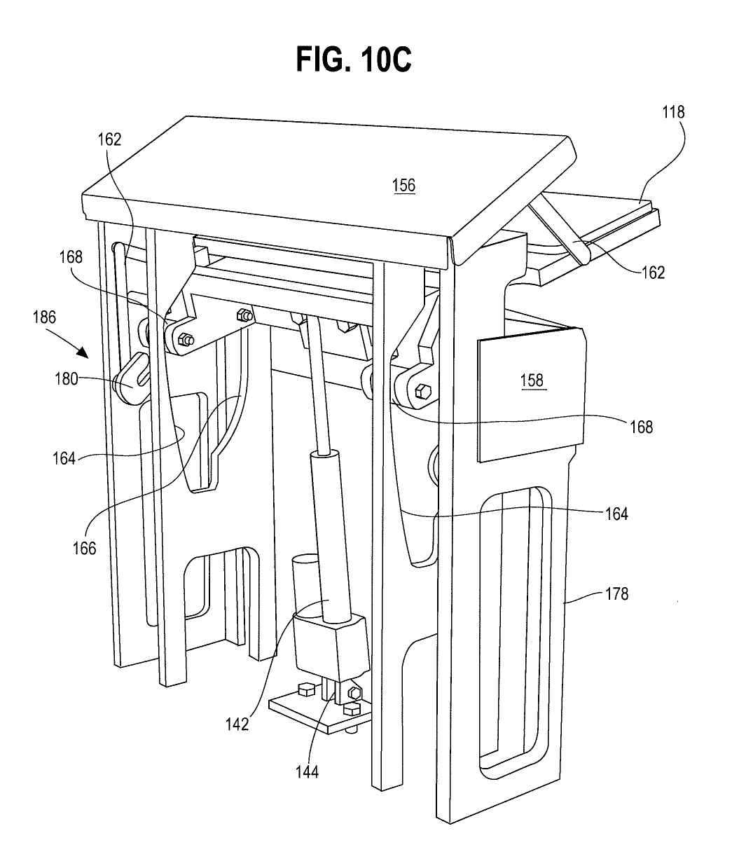

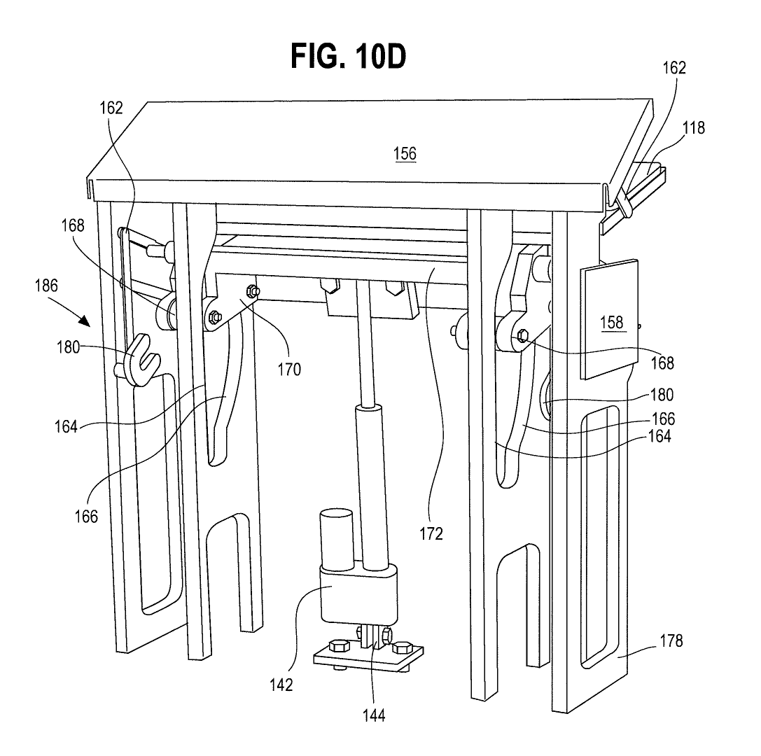

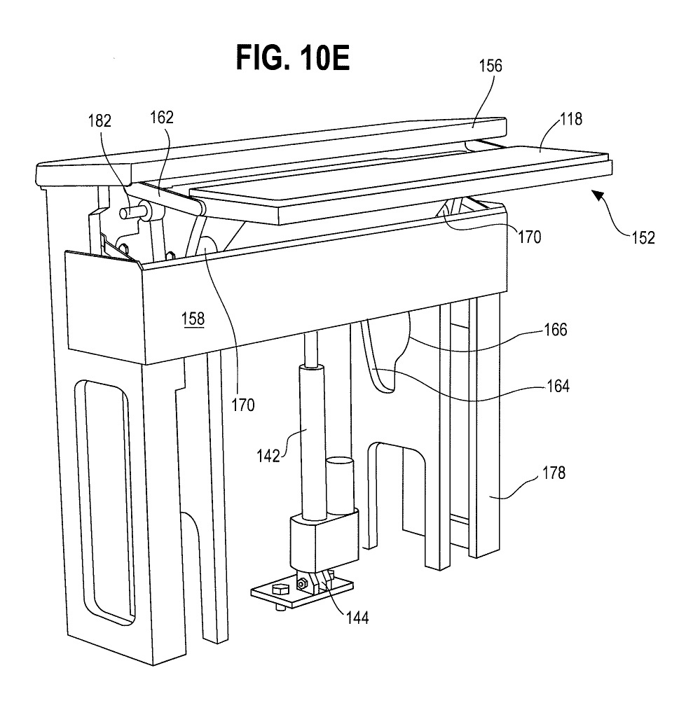

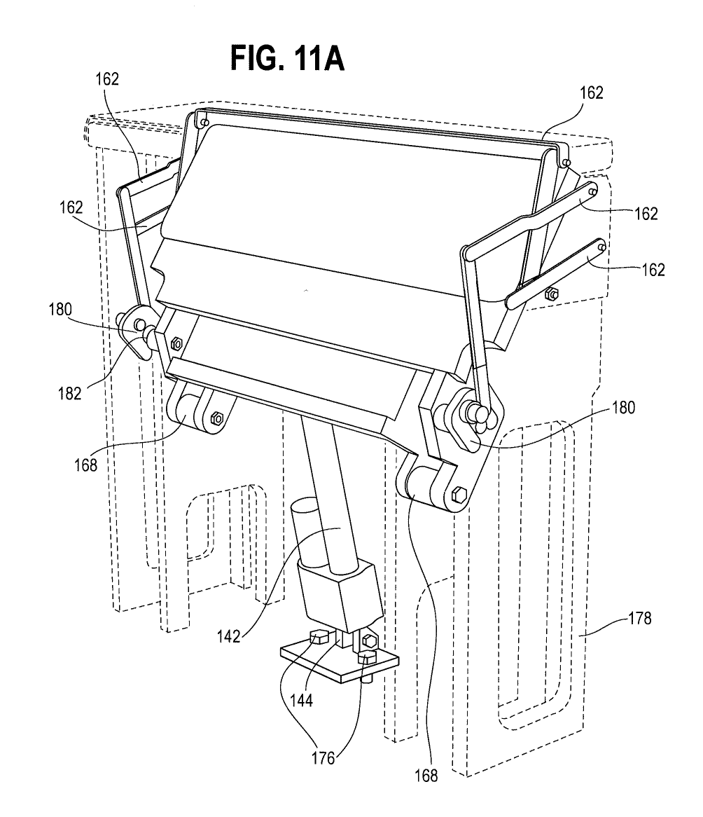

Referring ahead to FIGS. 10A-10E, only the moveable housing panels 148 are shown therein, while the remaining recess housing sections are removed to reveal the lifting pad driving mechanism 140 contained therein. The moveable housing panels 148 are operated by housing panel arms 162. The housing panel arms 162 are coupled to the lifting pad 118 on a first end and the moveable housing panel 148 on a second end. The moveable housing panels 148 shift to expose the lifting pad 118 in response to the lifting pad 118 moving from its initial, retracted position 154 and beginning deployment distal to the lift beam 116.

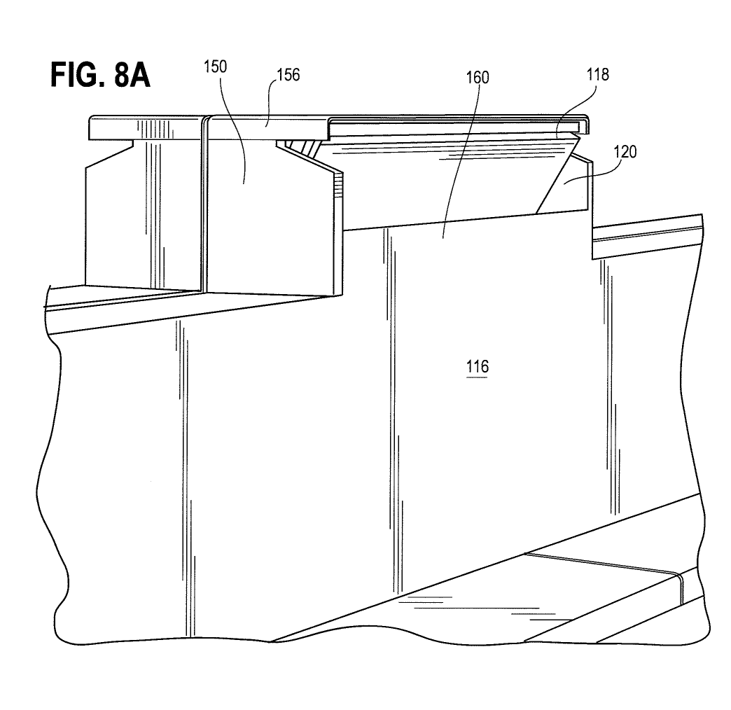

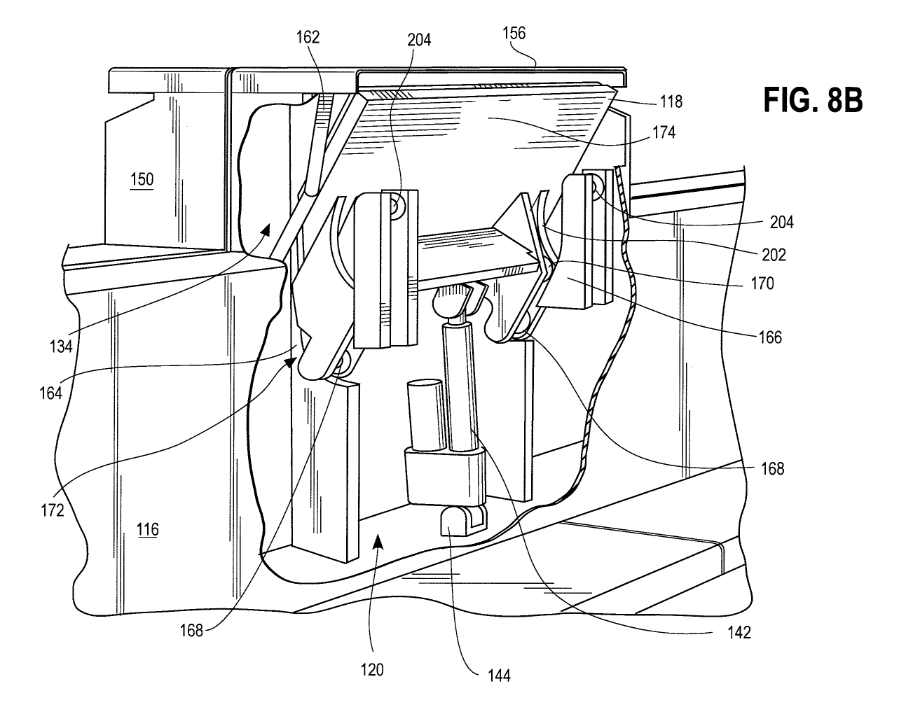

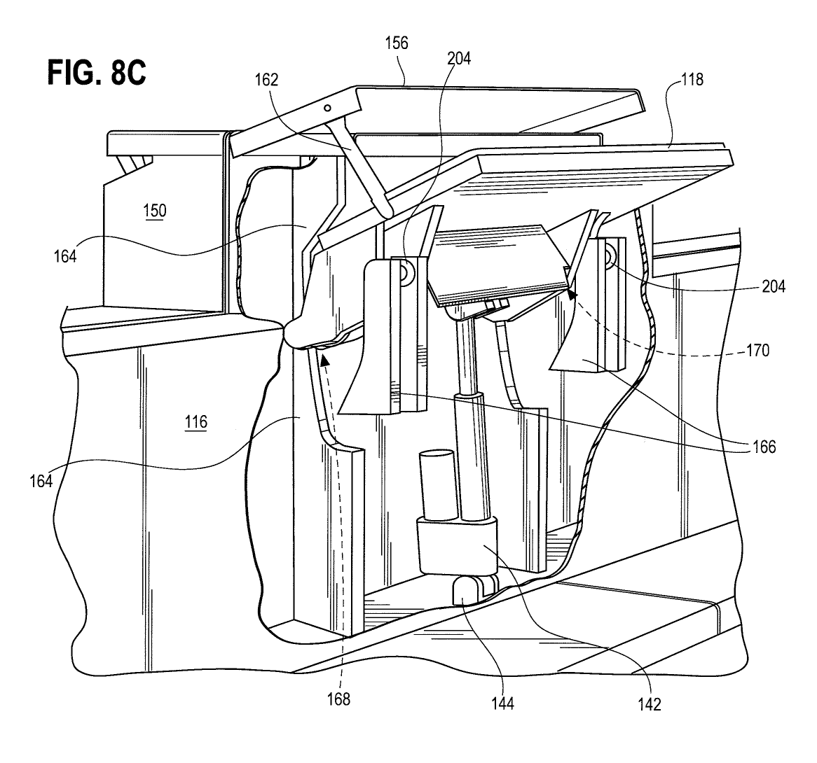

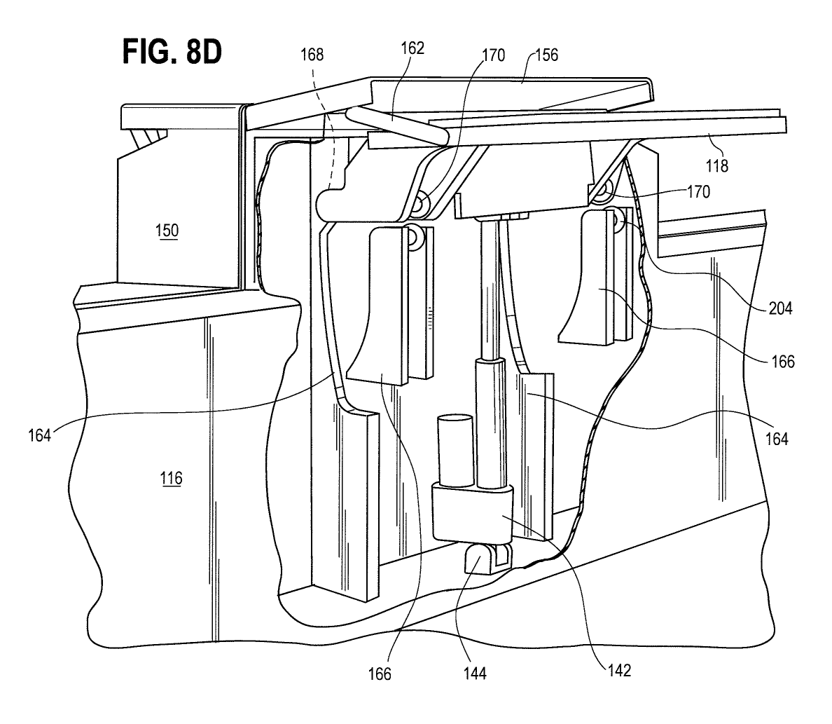

Referring now to FIGS. 8A-8D, the housing panel arms 162 connecting the top panel 156 to the lifting pad 118 are shown for a single lifting pad 118. However, in this example embodiment the partial interior side panel 158 is not depicted. The partial interior side panel 158 may also be omitted entirely, such that only the stationary, lower partial interior side panel 160 is present to house the lifting pad driving mechanism 140. In this example embodiment, the lifting pad 118 extends out through the gap between the stationary partial interior side panel 160 and the slightly raised top panel 156.

Referring still to FIGS. 8A-8D, the lifting pad 118 begins housed within the respective recess 120. In FIG. 8A, the lifting pad recess housing 150 is shown, including the panel opening that is present when the moveable partial interior side panel 158 is omitted. The recess housing 150 surrounds the lifting pad 118 and the lifting pad driving mechanism 140 including the housing panel arms 162, the linear actuator 142, and the lifting pad cams 164, 166.

Each lifting pad driving mechanism 140 is operated by the respective linear actuator 142. The linear actuator 142 is connected on a first end to the interior bottom panel of the lifting pad recess 146 within the lift beam 116. On a second end, the linear actuator 142 is connected to the lifting pad 118. Both connection points of the linear actuator 142 may include hinges or pivots that allow the linear actuator 142 to shift along a plane perpendicular to the length of the lift beam 116. As depicted in FIG. 8B, in an example embodiment, the linear actuator 142 may be oriented vertically when the lifting pad 118 is in the initial, retracted position 154 before the linear actuator 142 is actuated and the lifting pad 118 is deployed.

When the linear actuator 142 is actuated, the lifting pad 118 is deployed from within the recess 120. The lifting pad driving mechanism 140 guides the lifting pad 118 during deployment. Further, the lifting pad driving mechanism 140 slides open the recess housing 150 in response to actuation of the linear actuator 142. The lifting pad driving mechanism 140 is connected to two panels of the recess housing 150. As the lifting pad driving mechanism 140 moves to accommodate the deploying lifting pad 118, each moveable panel 148 of the recess housing 150 is shifted to develop an opening to the recess 120. Likewise, as the moveable panels 148 open to expose the recess 120, the lifting pad 118 is guided up and out of the recess 120 through the recess opening.

In an alternative example embodiment, the linear actuator 142 is actuated, as shown in FIG. 8C, and the pivot mounting 144 coupling the underside of the lifting pad 118 and the linear actuator 142 hinges to allow the cam movement of the lifting pad 118. In this example, the linear actuator 142 remains vertical during actuation, while the lifting pad 118 hinges about the changing vertical position of the linear actuator 142.

As the linear actuator 142 is actuated, the vertical force of the linear actuator 142 pushes the lifting pad 118 up and out of the lifting pad recess 120. As the lifting pad 118 is deployed, two cams 164, 166 on each side of the lifting pad driving mechanism 140 guide the lifting pad 118 from the tucked, initial position 154 inside the lifting pad recess 120 to the fully deployed position 152 distal to the lift beam 116 and partially out of the recess housing 150.

Referring now to FIG. 8B-8D, the lifting pad recess housing 150 is removed to show the lifting pad 118 and lifting pad driving mechanism 140 that are enclosed by the recess housing 150 when in the initial position 154. In the example embodiment shown here, the lifting pad 118 contacts the cam guides 164, 166 by way of cam guide bearings 168, 170 strategically placed at hinge points along the lifting pad 118. The cam guide profiles are configured to direct the end of the lifting pad 118 to a position that allows engagement of the lifting pad 118 with the container 106. During deployment, the lifting pad 118 may need to travel in the gap between the bottom edge 132 of the container 106 and tires associated with the chassis 108. Therefore, the trajectory at which the lifting pad 118 is deployed is controlled by the cam guide bearings 168, 170 through interaction with the cam guides 164, 166 of the lifting pad 118.

A back set of cam guides 164 guide the interior end 172 of the lifting pad 118. Interior bearings 168 located on either side of the interior end 172 of the lifting pad 118 rest in the bottom of these cam guides when the lifting pad 118 is in the initial, retracted position 154. Further, the back cam guides 164 guide the interior portion 172 of the lifting pad 118 such that the pad is extended and shifted to a horizontal orientation. To achieve these dual functions, the back cam guides 164 are formed in a “J”-shape.

Further in this example embodiment, the front cam guides 166 guide the bottom 174 of the lifting pad 118. The front cam guides 166 contact bottom bearings 170 configured on the bottom, underside 174 of the lifting pad 118. The front cams 166 push against the bottom lifting pad bearings 170 to cause the lifting pad 118 to rise generally upwards, out of the housing recess 120 before hinging towards horizontal deployment. The shape of the front cam guides 166 has a softer arc and forms a “j”-shape.

Once deployment is nearly complete, the bottom surface 174 of the lifting pad 118 slides on to a bar welded to the horizontal top edge of the stationary interior side panel 160. Then a point on the top surface of the lifting pad 118 makes contact with a bar welded to the underside of the housing. These contact points are established when the lifting pad 118 is “locked out” in the fully deployed position 152 and the moment created thereby provides structural support for the lifting pad 118 to bear the weight of the container 106 and transfer said weight to the two contact points. To achieve the final trajectory of the lifting pad 118, a cam surface 202 on the lifting pad 118 establishes contact with rollers 204 mounted to the end of the front cam guide 166. The transition to this fully deployed position 152 will cause the cam guide bearings 170 that initially contact the front cam guides 166 to lift off from the front cam guides 166 slightly. The contact points during full deployment of the lifting pad 118 transfer the downward load of the container 106 from the lifting pad 118 to the lift beam 116.

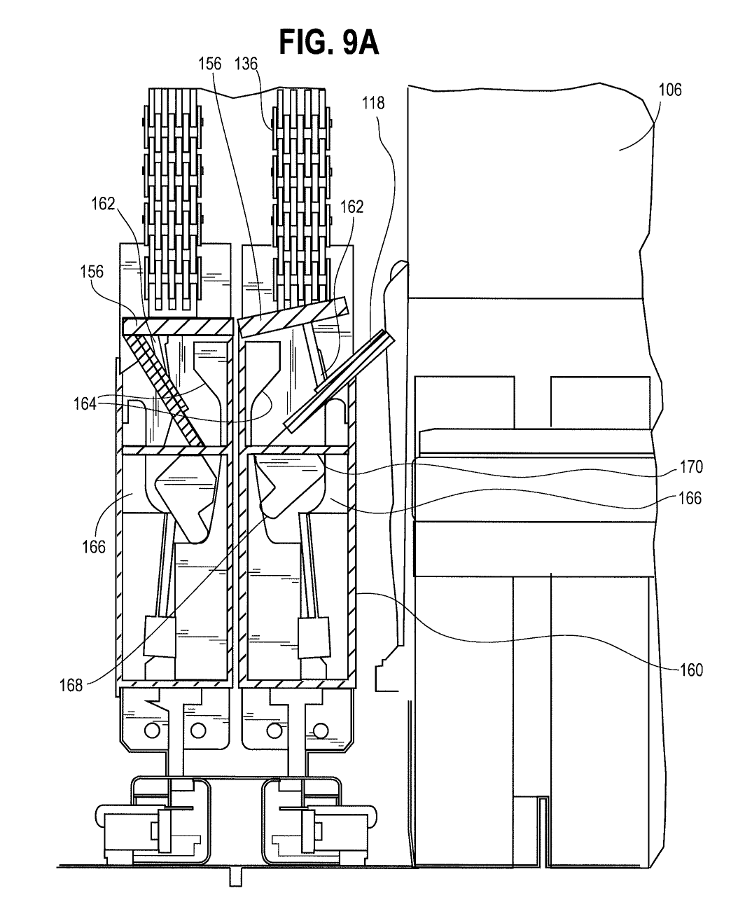

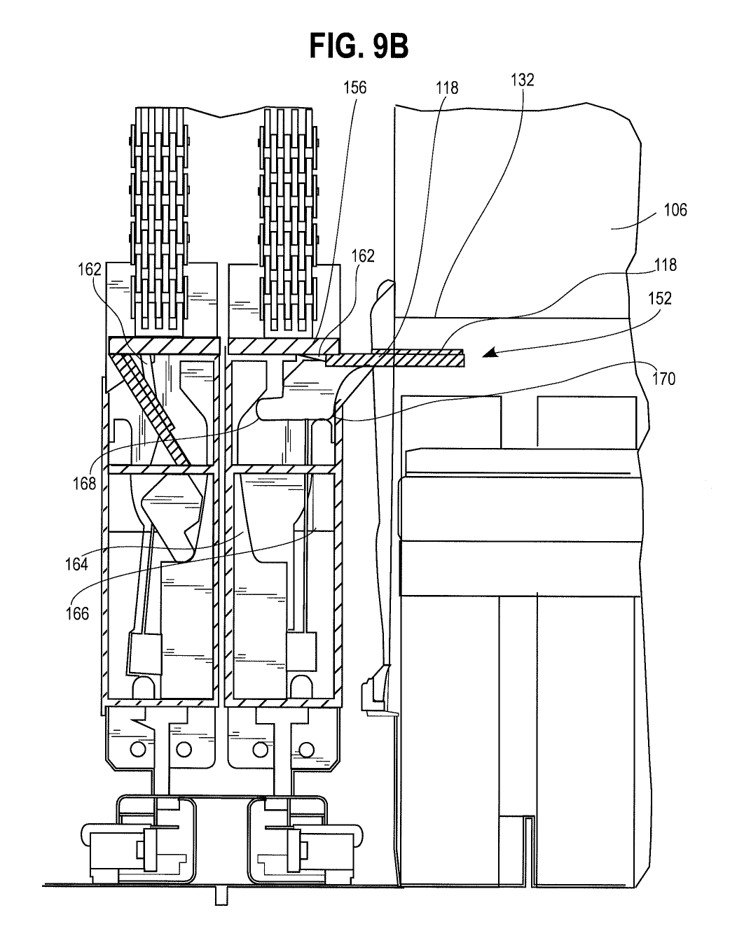

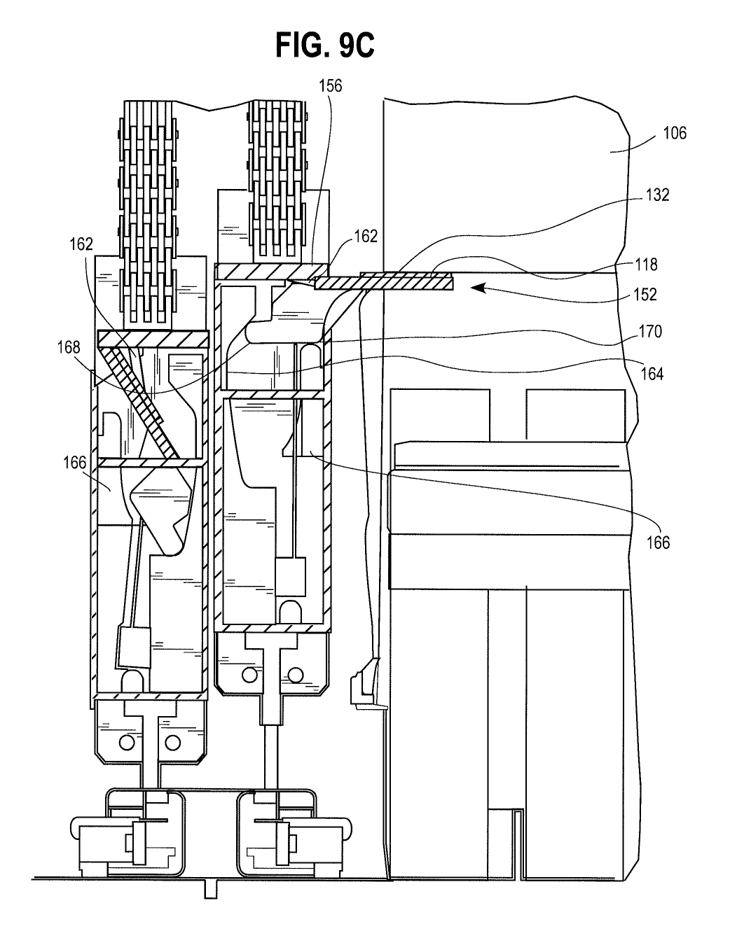

Referring now to FIGS. 9A-9C, a cross-section of the lifting pad 118, lifting pad driving mechanism 140, and recess housing 150 is depicted. Here, the path of the lifting pad 118 as it interacts with the front and back cam guides 164, 166 is shown. The cross-sectional view shows the up and then out movement of the lifting pad 118. Further, the operation of the moveable top panel 156 is shown in relation to the progress of the lifting pad 118 deployment.

Referring specifically to FIGS. 9B and 9C, the final, fully deployed position 152 of the lifting pad 118 is shown. The final arrangement of the lifting pad 118 and the cam guide bearings 168, 170 along the front and back cam guides 164, 166 determines the final deployment position 152 of the lifting pad 118. The cam guide bearings 168, 170 work together with the front and back cam guides 164, 166 to provide a stable lifting pad position for engaging the edge 132 of the container 106 and, further, for hoisting the container 106. The linear actuator 142 further provides assistance in stabilizing the lifting pad 118 for bearing the weight of the container 106. Also, as seen in FIGS. 9B and 9C, following full deployment of the lifting pad 118, the moveable top panel 156 of the recess housing 150 returns to an initial, closed position.

Referring now to FIGS. 10A-10E, the lifting pad 118 and lifting pad driving mechanism 140 are shown in detail with the recess housing 150 removed (except for the moveable housing panel 148). Here, the lifting pad 118 and lifting pad driving mechanism 140 are shown at varying angles and in varying stages of lifting pad deployment. Referring first to FIG. 10A, in this example embodiment the linear actuator 142 has an initial position at an angle towards the back of the lifting pad recess 120. Two fasteners 176, such as bolts or screws, hold the hydraulic cylinder pivot mounting 144 to the interior of the bottom panel of the lifting pad recess 146. Further, in FIG. 10A, both the moveable top panel 156 and the moveable partial interior side panel 158 are shown in the initial, closed position. Also shown in the initial position are the interior cam guide bearings 168 of the lifting pad 118 at rest in the bottom portion of the back cam guides 164. The example embodiment shown in FIGS. 10A-10E, incorporate both cam surfaces on to a single plate.

FIG. 10A depicts a portion of the housing that forms supports for the cam guides 164, 166 and lifting pad driving mechanism 140. The partial housing supports 178 anchor the housing panel arms 162. Further, the housing panel arms 162 include, at an interior end, a housing panel release 180. The housing panel release 180 is a “U” shaped mechanism coupled to the housing panel arms 162 and anchored to the partial housing supports 178. The lifting pad 118 has two housing panel arm bars 182, one located on either side of the lifting pad 118, that interact with the housing panel release 180 to coordinate the operation of the moveable housing panels 148 and the lifting pad 118. When the lifting pad 118 is in the initial, retracted position 154, each housing panel arm bar 182 is engaged with the respective housing panel release 180 anchored along the partial housing support 178 of the same side. In the initial position, the housing panel release 180 is oriented such that the opening of each release faces generally downward. Each housing panel arm bar 182 rests in the upward facing housing panel release 180.

Referring now to FIG. 10B, the linear actuator 142 begins to actuate and extends against the bottom 174 of the lifting pad 118. Thus, the lifting pad 118 begins to move up and out of the lifting pad recess 120. The interior and bottom bearings 168, 170 are guided by the back and front cam guides 164, 166. Seen here, the interior bearings 168 have moved part way up the back cam guides 164. As the linear actuator 142 actuates and the lifting pad 118 moves, the housing panel arms 162 coupled to either side of the lifting pad 118 are likewise operated. The operation of the housing panel arms 162, as discussed above, raises the top panel 156 and lowers the partial interior side panel 158.

Further, as the moveable panels 148 are shifted, the housing panel arm bars 182 withdraw from the housing panel releases 180 on the partial housing supports 178 on either side of the recess 120. During the lifting pad deployment stage depicted in FIG. 10B, the housing panel arm bars 182 rise out of the housing panel releases 180. In order for the housing panel arm bars 182 to exit the housing panel releases 180, first each housing panel release 180 must swivel from the downward, locked position 184 (FIG. 10A) to the generally upward facing release position 186 (FIG. 10B).

As shown in FIGS. 10B-10D, the housing panel arms 162 are shown connecting the moveable panels 148 and the housing panel arm bars 182. When the housing panel arm bars 182 rise out of the housing panel releases 180, the moveable housing panels 148 are operated according to the motion of the lifting pad 118. Thus, the moveable panels 148 open, and remain in the open position, through the deployment of the lifting pad 118. Further, the moveable housing panels 148 are under the control of the lifting pad 118 by way of the housing panel arms 162. The housing panel releases 180 remain in the generally upward facing release position 186 during the remaining deployment of the lifting pad 118, such that the housing panel releases 180 are positioned to accept the housing panel release arm bars 182 during retraction of the lifting pad 118.

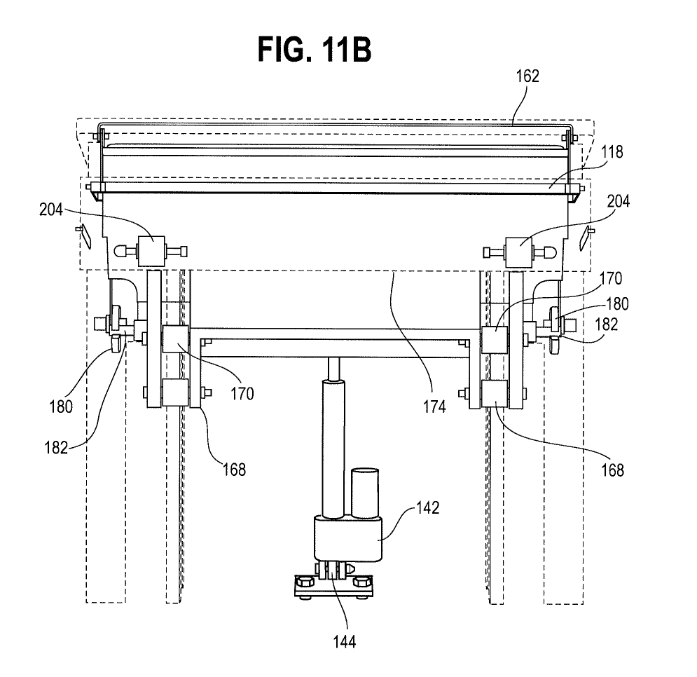

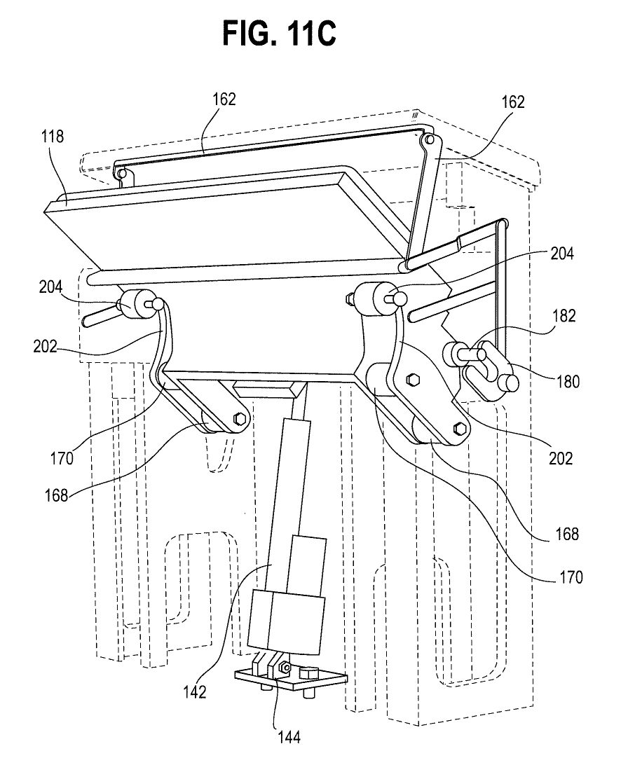

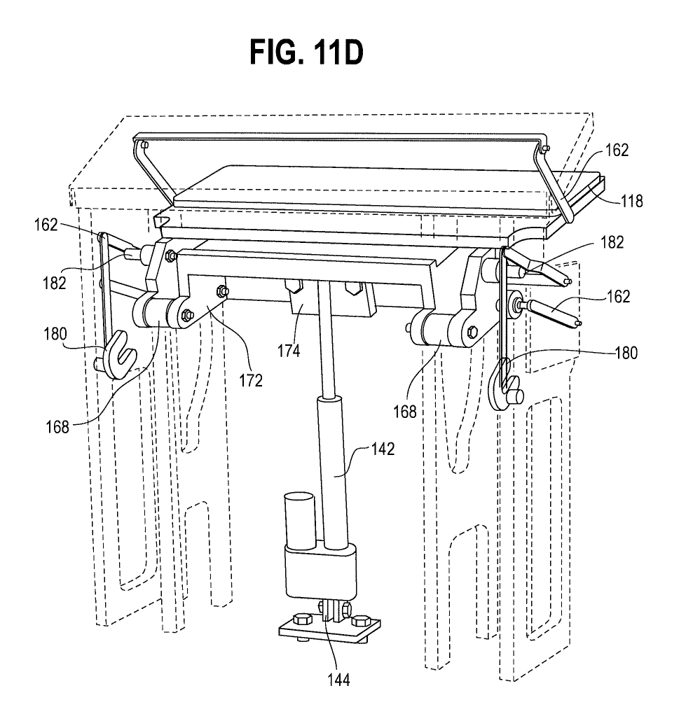

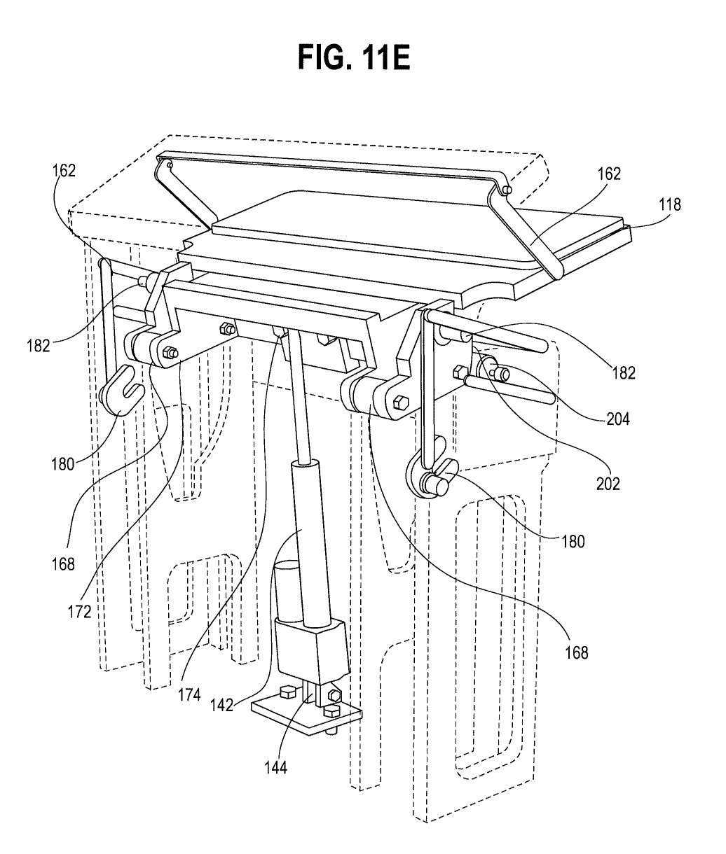

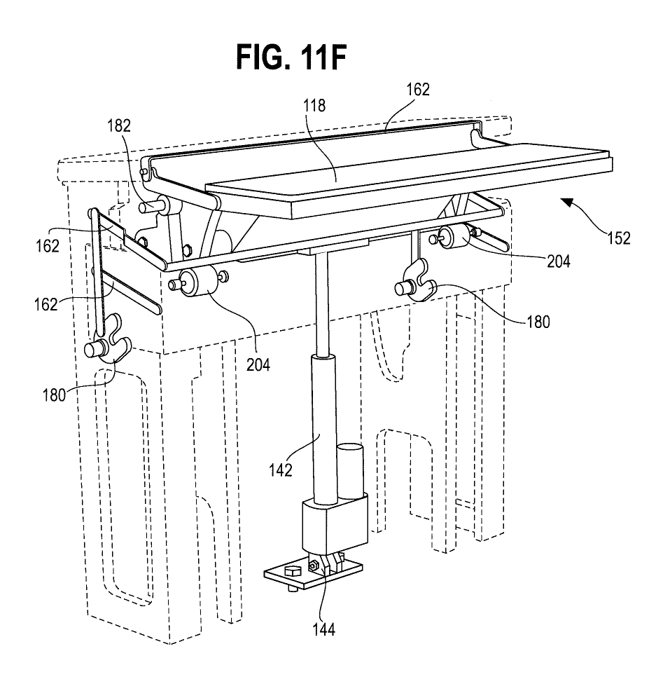

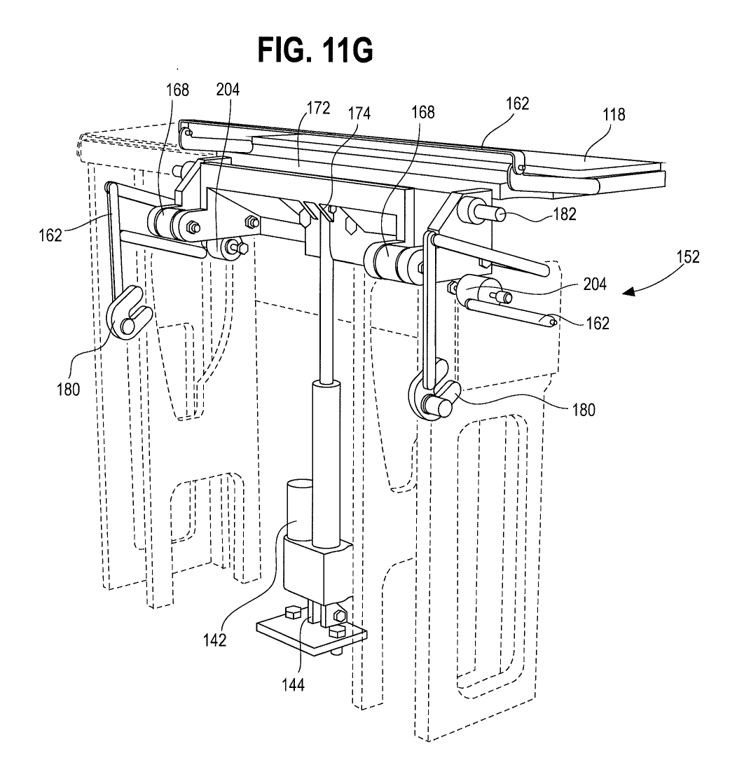

Referring now to FIGS. 11A-11G, the lifting pad 118 and lifting pad driving mechanism 140 are shown in detail at varying angles and in varying stages of lifting pad deployment. In the drawings of FIGS. 11A-11G, the recess housing 150 is removed and the lifting pad cam guides 164, 166 are shown as transparent to provide more detailed views of the lifting pad driving mechanism 140. The configuration of the moveable housing panel arms 162 is shown through the partially transparent housing supports 178.

As the lifting pad 118 is deployed beginning with FIG. 11A and continuing until the lifting pad 118 is fully deployed 152 in FIGS. 11F and 11G, the operation of the housing panel arms 162 is shown in greater detail. The change in the angle of the housing panel arms 162 in relation to each other from FIG. 11A to FIG. 11C demonstrates how the moveable housing panels 148 are shifted to the open position by the housing panel arms 162. Further, FIGS. 11F and 11G show in greater detail the “locked out” position of the lifting pad 118 attained when the lifting pad 118 is fully deployed 152 and is prepared to bear the weight of the container 106. Further, when the lifting pad 118 is fully deployed the linear actuator 142 may be at full stroke and therefore completion of actuation corresponds with the “locked out” position. This configuration such that the linear actuator 142 is at full stroke when the lifting pad 118 reaches full deployment also may help prevent the lifting pad from travelling too far forward, out of the recess 120.

The embodiment(s) detailed above may be combined, in full or in part, with any alternative embodiment(s) described.

As many changes could be made in the above constructions without departing from the scope of the disclosure, it is intended that all matter contained in the above description or shown in the accompanying drawings, can be interpreted as illustrative and not in a limiting sense.

### INDUSTRIAL APPLICABILITY

Important advantages of the lift beam system include lifting pads that recess into the lift beam, hydraulic cylinders for deploying the lifting pads, and lifting chains capable of hoisting a shipping container. Another important advantage of the lift beam system is the potential combination of such system with the Automatically Aligning Chassis Guides.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

We claim:

1. A system for handling shipping containers comprising:
first and second lift beams;
first and second support beams;
a plurality of vertical beams wherein the plurality of vertical beams are connected by the first and second lift beams and the first and second support beams;
first and second pluralities of lifting pads disposed respectively on each of the first and second lift beams;
the lifting pads of the first and second pluralities arranged to have an initial position recessed within the respective lift beam on which each lifting pad is disposed;
the lifting pads of the first and second pluralities arranged to have a deployed position distal to the respective lift beam on which each lifting pad is disposed;
first and second pluralities of swivel feet disposed respectively on each of the first and second support beams; and
a lift beam driving mechanism that raises and lowers the first and second lift beams.

2. The system of claim 1, further comprising:
the first and second pluralities of swivel feet arranged to support a shipping container when the shipping container is in an upper containment cavity; and
the first and second pluralities of lifting pads arranged to support the shipping container when the shipping container is in a lower containment cavity or the upper containment cavity, wherein the first and second lift beams move the lifting pads between the lower containment cavity and the upper containment cavity.

3. The system of claim 1, further comprising:
the first and second pluralities of lifting pads arranged to support the shipping container when the lifting pads are in the deployed position and the shipping container is in the lower containment cavity or the upper containment cavity; and
the first and second lift beams hoisting the shipping container from the lower containment cavity to the upper containment cavity.

4. The system of claim 3, further comprising:
the first and second pluralities of lifting pads arranged to transfer support of the shipping container to the first and second pluralities of swivel feet when the shipping container is in the upper containment cavity; and
the first and second pluralities of swivel feet supporting the shipping container in the upper containment cavity while the first and second lifting beams move from the upper containment cavity to the lower containment cavity.

5. The system of claim 4, further comprising:
the first and second pluralities of lifting pads arranged to support an additional shipping container once the first and second lifting beams move from the upper containment cavity to the lower containment cavity; and
the first and second pluralities of lifting pads supporting the additional shipping container in the lower containment cavity.

6. The system of claim 5, further comprising:
the first and second pluralities of swivel feet are arranged to have an initial position tucked proximal the respective first and second support beams; and
the first and the second pluralities of swivel feet arranged to have a deployed position extending out from the respective first and second support beams;
wherein the first and second pluralities of swivel feet are arranged to support the shipping container when in the deployed position.

7. The system of claim 6, further comprising:
first and second pluralities of swivel feet actuators;
the first and second pluralities of swivel feet actuators arranged such that each swivel foot actuator operates to rotate the respective swivel foot from the initial tucked position to the deployed position; and
each swivel foot actuator arranged to retract the respective swivel foot from the deployed position back to the initial tucked position proximal the respective support beam.

8. The system of claim 1, further comprising:
first and second pluralities of recesses disposed respectively on each of the first and second lift beams;
wherein each of the lifting pads has a respective recess of the first and second pluralities of recesses aligned therewith.

9. The system of claim 8, further comprising:
each lifting pad of the first and second pluralities arranged to be enclosed by the respective recess when the lifting pad is in the initial position; and
each lifting pad of the first and second pluralities arranged to extend out from the respective recess when the lifting pad is in the deployed position.

10. The system of claim 9, further comprising:
each recess of the first and second pluralities of recesses comprising more than one panel such that the respective more than one panel and the respective lift beam are arranged to form each recess.

11. The system of claim 10, further comprising:
the more than one panel of each of the recesses of the first and second pluralities arranged so that at least one panel is in a closed position when the respective lifting pad is in the initial position; and
the at least one panel arranged to move to an open position when the respective lifting pad is in the deployed position.

12. The system of claim 11, further comprising:
first and second pluralities of lifting pad driving mechanisms;
each lifting pad of the first and second pluralities of lifting pads arranged to be coupled to a respective lifting pad driving mechanism of the first and second pluralities of lifting pad driving mechanisms; and
the at least one panel of each of the recesses of the first and second pluralities is coupled to the respective lifting pad or the respective lifting pad driving mechanism.

13. The system of claim 12, further comprising:
lifting pad cams disposed within each recess of the first and second pluralities of recesses; and
the lifting pad cams arranged to guide each lifting pad of the first and second pluralities of lifting pads.

14. The system of claim 12, further comprising:
each lifting pad driving mechanism arranged to move the respective lifting pad and the respective at least one panel such that the lifting pad is guided by the lifting pad cams along a path that moves the lifting pad up and out of the recess at the same time that the at least one panel moves from the closed position to the open position.

15. The system of claim 12, wherein the lifting pad driving mechanism is one of an electric actuator, a hydraulic cylinder, and a pneumatic actuator.

16. The system of claim 12, further comprising:
the first and second pluralities of lifting pad driving mechanisms arranged to retract each respective lifting pad such that the lifting pads move from the deployed position out of the recesses to the initial position within the recesses.

17. A system for raising and lowering shipping containers, comprising:
at least one lift beam having a plurality of lifting pads disposed therealong;
at least one support beam having a plurality of swivel feet disposed therealong; and
a lower containment cavity and an upper containment cavity, wherein the at least one lift beam moves between a first position in the lower containment cavity and a second position in the upper containment cavity;
wherein the plurality of lifting pads and the plurality of swivel feet are configured to transfer a container therebetween when the lift beam is at the second position;
wherein the plurality of lifting pads have a first initial position and a first deployed position and the plurality of swivel feet have a second initial position and a second deployed position such that the plurality of lifting pads and the plurality of swivel feet are configured to support the container in the first and second deployed positions respectively.

18. The system of claim 17, further comprising:
the at least one lift beam having a plurality of recesses wherein each of the plurality of lifting pads is aligned with an associated recess of the plurality of recesses; and wherein each of the plurality of recesses is formed by at least one housing panel.

19. The system of claim 18, further comprising:
the plurality of lifting pads arranged such that the first initial position of the lifting pads is within the respective recesses; and
the plurality of lifting pads arranged to move from the first initial position of the lifting pads to the first deployed position of the lifting pads by deploying through an opening developed by the at least one housing panel.

20. The system of claim 19, further comprising:
a plurality of lifting pad driving mechanisms for deploying the plurality of lifting pads; and
a plurality of swivel feet actuators for deploying the plurality of swivel feet.

21. The system of claim 20, further comprising:
the plurality of lifting pads arranged to deploy to the first deployed position out and up relative the plurality of recesses and the at least one lift beam; and
the plurality of swivel feet arranged to deploy to the second deployed position by rotating horizontally.

22. The system of claim 21, wherein the plurality of lifting pads and the plurality of swivel feet deploy to the first and second deployed positions, respectively, underneath the container before supporting the container.

23. The system of claim 22, wherein the plurality of lifting pads and the plurality of swivel feet are configured to support the container and another container at the same time.
